(19) United States
(12) Patent Application Publication
(10) Pub. No.: US 2009/0058115 A1
(43) Pub. Date: Mar. 5, 2009

(54) LITTER BOX CLEANING DEVICE

(75) Inventors: Melvin Stanley Freedman, Chicago, IL (US); Mark Alan Rutman, Beachwood, OH (US)

Correspondence Address: WILDMAN HARROLD ALLEN & DIXON LLP, 225 WEST WACKER DRIVE, SUITE 2800, CHICAGO, IL, 60606, US

(73) Assignee: VETERINARIAN'S CHOICE, LLC, Chicago, IL (US)

(21) Appl. No.: 12/199,133

(22) Filed: Aug. 27, 2008

Related U.S. Application Data
(60) Provisional application No. 60/968,172, filed on Aug. 27, 2007.

(51) Int. Cl. A01K 29/00

(52) U.S. Cl. 294/55

(57) ABSTRACT

A litter box cleaning device is provided. In some examples, the litter box cleaning device may include a basket, a handle, and a cover removably connected to the basket. In other examples, the litter box cleaning device may include a basket having a bottom wall with an aperture defined therethrough near a rear of the bottom wall and a filter removably connected to the basket. In yet other examples, the litter box cleaning device may include a slotted basket, a handle, a retractable scraper blade that extends from and retracts into the basket, at least one cleaning plate that cleans debris from the scraper blade, and a removable transparent cover attached to the basket. In such examples, the litter box cleaning device may be operated by engaging an actuator to extend a scraper blade from the slotted basket and re-engaging the actuator to retract the scraper blade into the basket.

### RELATED APPLICATIONS

The present application claims priority to U.S. Provisional Patent Application No. 60/968,172, filed Aug. 27, 2007, the content of which is incorporated herein by reference.

### FIELD OF THE INVENTION

The present invention relates to litter box cleaning tools.

### BACKGROUND OF THE INVENTION

Conventional litter box cleaning tools, such as scoopers, usually cannot completely and efficiently remove solid and clumped litter and other debris that adheres to the bottom and sides of a litter box. In addition to being a problem from the user's point of view, this is a problem because these remaining wastes increase the risk of exposing the animal using the litter box to harmful bacteria that also may be left behind.

In addition, during the normal scooping process, litter dust rises from the litter box and can be inhaled by the user doing the scooping, which can be detrimental to the health of the user.

Finally, when wet litter is scraped off of the surface of a litter box, clumped litter tends to adhere to the front edge of the scooper, which is a constant annoyance and requires time and effort on the part of the user to then clean the scooper after cleaning the litter box.

Therefore, it would be beneficial to have a litter box cleaning device that thoroughly and conveniently cleans the bottom and sides of litter boxes, a litter box cleaning device that does not require cleaning of the device after cleaning of the litter box, and a litter box cleaning device that reduces the risk of inhaling potential harmful dust formed during the scooping process.

### SUMMARY

In one example, a litter box cleaning device is provided having a slotted basket, a handle attached to the basket, and a retractable scraper blade that extends from and retracts into the basket.

In another example, a litter box cleaning device is provided having a slotted basket, a handle attached to the basket, a retractable scraper blade that extends from and retract into the basket, and at least one cleaning plate that cleans debris from the scraper blade when the scraper blade is retracted.

In yet another example, a litter box cleaning device is provided having a slotted basket, a handle attached to the basket, and a transparent cover attached to and removable from the basket.

In still another example, a method of using a litter box cleaning device is provided having the steps of: engaging an actuator to extend a scraper blade from the slotted basket of the cleaning device; and re-engaging the actuator to retract the scraper blade from the slotted basket of the cleaning device.

In a further example, a litter box cleaning device is provided having a basket including a bottom wall and a sidewall extending from the bottom wall, the bottom wall and the side wall together defining a receptacle for receiving debris; a handle extending from the basket; and a cover removably connected to the basket and operable to at least partially cover the receptacle when connected to the basket.

In yet a further example, a litter box cleaning device is provided having a basket including a bottom wall and a sidewall extending from the bottom wall, the bottom wall and the sidewall together defining a receptacle for receiving debris, the bottom wall having a front and a rear and including an aperture defined through the bottom wall near the rear of the bottom wall; a handle extending from the basket; and a filter removably connected to the basket and including at least one slot therethrough such that the filter is at least partially positioned in the receptacle and above the bottom wall with the filter connected to the basket.

### BRIEF DESCRIPTION OF THE DRAWINGS

FIG. 1 is a side perspective view of one example of a litter box cleaning device.

FIG. 2 is a front perspective view of the litter box cleaning device of FIG. 1 with the hood removed.

FIG. 3 is a top perspective view of the litter box cleaning device of FIG. 1.

FIG. 4 is a front view of the litter box cleaning device of FIG. 1.

FIG. 5 is a top view of the litter box cleaning device of FIG. 1.

FIG. 6 is a side view of the litter box cleaning device of FIG. 1.

FIG. 7 is an exploded view of the litter box cleaning device of FIG. 1.

FIG. 8 is a bottom perspective view of the litter box cleaning device of FIG. 1.

FIG. 9 is a bottom perspective view of the litter box cleaning device of FIG. 8 with the back plate removed.

FIG. 10 is a bottom perspective view of the litter box cleaning device of FIG. 8 with the back plate and grip removed.

FIG. 11 is an enlarged, partial, bottom perspective view of the litter box cleaning device of FIG. 10.

FIG. 12 is another enlarged, partial, bottom perspective view of the litter box cleaning device of FIG. 10.

FIG. 13 is a top perspective view of the litter box cleaning device of FIG. 1 with the hood and grip removed.

FIG. 14 is a side perspective view of the litter box cleaning device of FIG. 1 with the hood, basket, handle, and grip removed.

FIG. 15 is a top perspective view of the back plate of the litter box cleaning device of FIG. 1.

FIG. 16 is an enlarged, partial, side perspective view of the handle and actuator assembly of the litter box cleaning device of FIG. 1.

FIG. 17 is a top perspective view of the blade of the litter box cleaning device of FIG. 1

FIG. 18 is an enlarged, partial, top perspective view of the litter box cleaning device of FIG. 1 with an alternate grip.

FIG. 19 is a top perspective view of another example of a litter box cleaning device.

FIG. 20 is a bottom perspective view of the litter box cleaning device shown in FIG. 19.

FIG. 21 is an exploded view of the litter box cleaning device shown in FIG. 19.

FIG. 22 is a top view of the litter box cleaning device shown in FIG. 19.

FIG. 23 is a cross-sectional view taken along line 23-23 in FIG. 22.

FIG. 24 is a cross-sectional view similar to FIG. 23 showing another exemplary manner for connecting a cover to a basket of the litter box cleaning device.

FIG. 25 is a cross-sectional view of the litter box cleaning device taken along line 25-25 in FIG. 22, shown with the litter box cleaning device in a first or scooping orientation.

FIG. 26 is a cross-sectional view similar to FIG. 25, shown with the litter box cleaning device in a second or carrying orientation.

FIG. 27 is a top perspective view of another example of a litter box cleaning device, shown with a locking mechanism for removably securing a filter to the litter box cleaning device.

FIG. 28 is a cross-sectional view of the litter box cleaning device of FIG. 27 taken along line 28 -28 in FIG. 27.

FIG. 29 is a top perspective view of another example of a litter box cleaning device, shown with another example of a locking mechanism for removably securing a filter to the litter box cleaning device.

FIG. 30 is a cross-sectional view of the litter box cleaning device of FIG. 29, taken along line 30 -30 in FIG. 29.

FIG. 31 is a top perspective view of another example of a litter box cleaning device, shown with another example of a locking mechanism for removably securing a filter to the litter box cleaning device.

FIG. 32 is an exploded view of the litter box cleaning device shown in FIG. 31.

FIG. 33 is a cross-sectional view of the litter box cleaning device of FIG. 31, taken along line 33-33 in FIG. 31.

### DETAILED DESCRIPTION

Referring now to the figures, examples of a litter box cleaning device 10 are shown. The litter box cleaning device 10 shown herein can be used to remove soiled and clumped litter from a litter box in a quick and easy manner that is healthier for the user and the animal. The device shown also addresses many potential health risks associated with cleaning a litter box, such as more sanitary removal of the soiled and clumped litter, quicker removal of the soiled and clumped litter, and increased ease of use.

The device 10 described herein generally has basket 20, handle 30, back plate 40, retractable scraper blade 50, cleaning plates 60, and an actuator assembly, which in the examples shown is formed by switch 72, flexible strip 74, and locking member 80.

In the example shown, basket 20 is made of acrylonitrile butadiene styrene (ABS), is approximately 132 mm in height, 95 mm in width, and 125 mm deep, and is generally formed by side wall 22 and bottom wall 26. The large basket 20 allows for a greater volume of litter to enter the basket with each scoop, which allows for quicker removal of the soiled and clumped litter. In this example, the front edge of bottom wall 26 is generally straight, the back edge is curved, and the surface of bottom wall 26 has a slight curvature to assist is keeping the clumped litter in basket 20 during removal. During removal of the clumped litter from the litter box, device 10 will be moved from an elevated position to an approximately horizontal position when the user removes the clumped litter from the litter box and moves device 10 to a waste basket. When this occurs, the slight curvature in bottom wall 26 will raise the front edge of bottom wall 26, which will make any clumped litter tend to roll back into basket 20 rather than out of basket 20. A cavity 27 is formed within bottom wall 26 below the top surface and receives scraper blade 50, as described in more detail below. In addition, multiple slots 28 are formed in bottom wall 26 to allow the passage of un-clumped litter or other debris. In this example, slots 28 are elongated and have a width of approximately 5 mm and a length that varies according to the position of the slot.

Side wall 22 extends from the side and back edges of bottom wall 26 and is substantially perpendicular to bottom wall 26. Side wall 22 increases in height from the front edge of bottom wall 26 to the back edge of bottom wall 26 such that the highest portion of side wall 22 is located along the centerline of device 10. The height of side wall 22 assists in preventing soiled and clumped litter from falling back on the hand of the user while in use. Multiple slots 24 are also formed in side wall 22 to allow the passage of un-clumped litter or debris when device 10 is in use. In this example, slots 24 are approximately 5 mm wide and the length varies depending on the location of the slot 24.

The number and width of slots 28 and 24 allow clean litter to pass through and return to the litter box quicker, which allows the user to sift larger volumes of litter more quickly and efficiently.

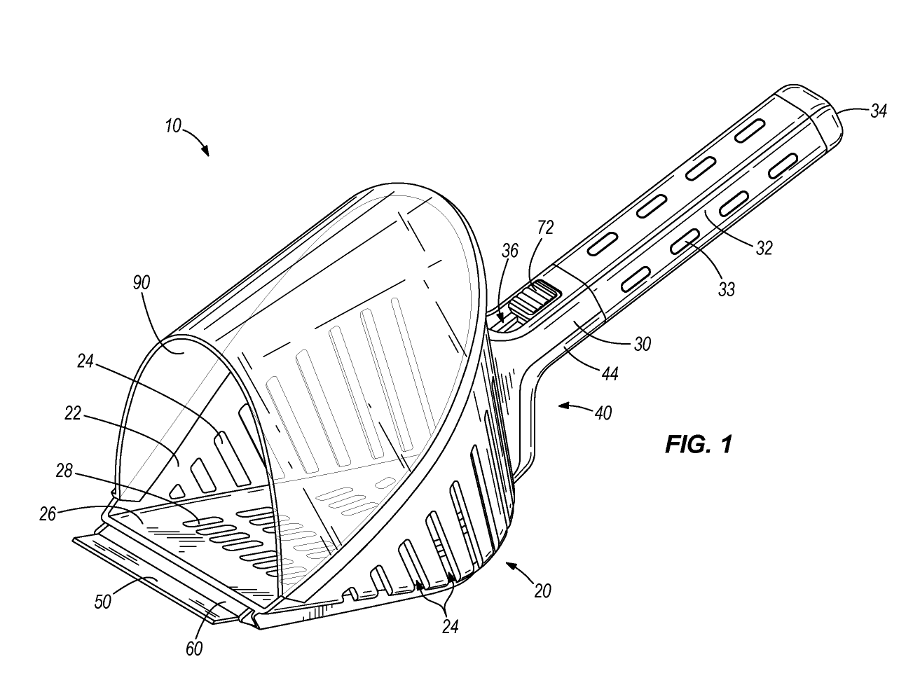

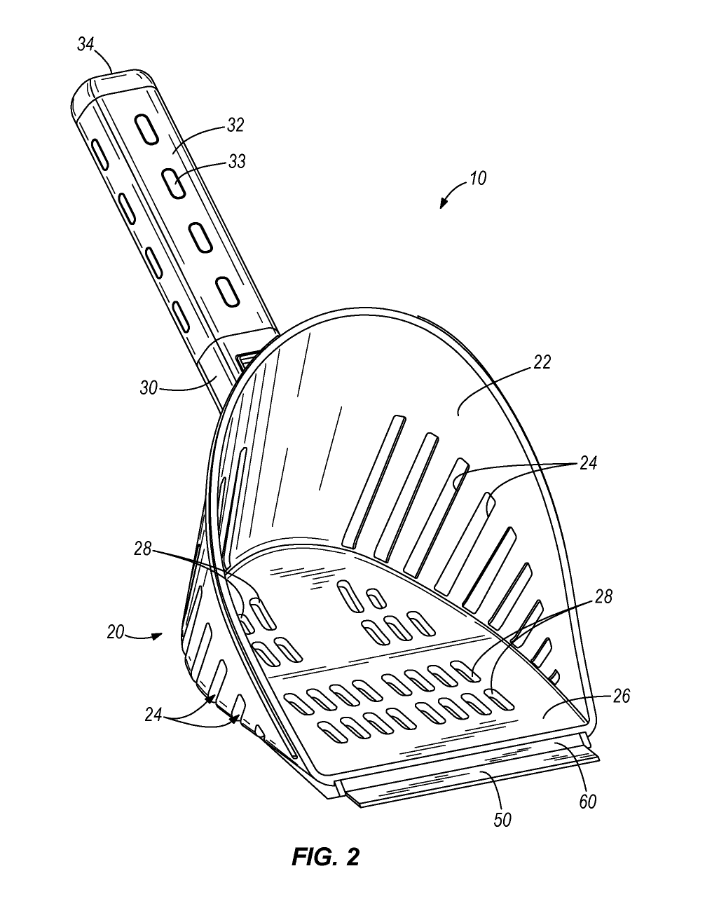

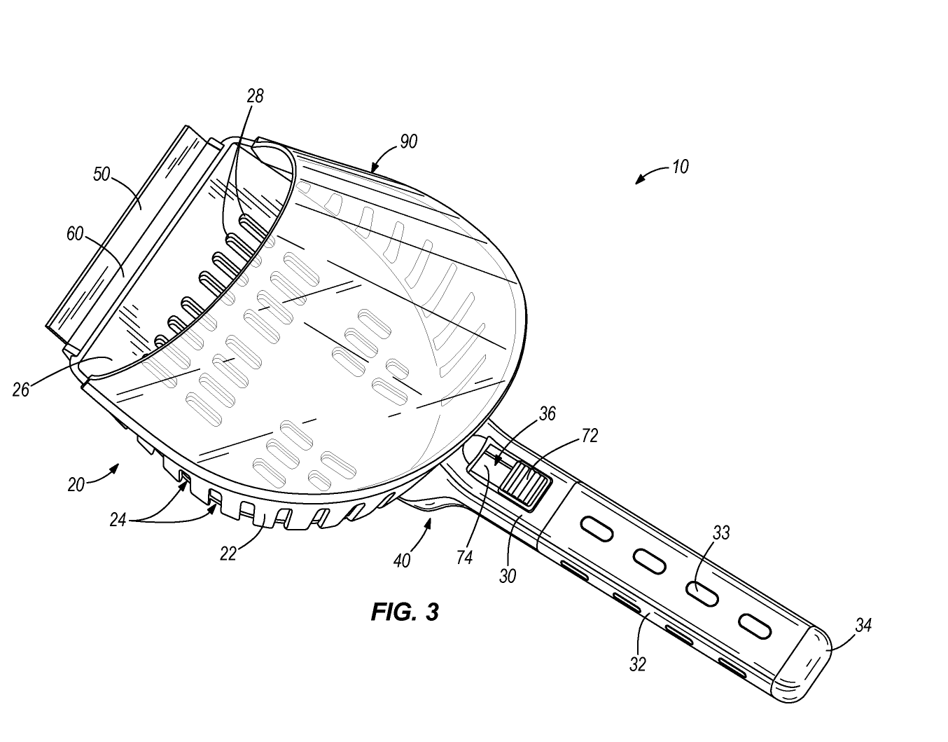

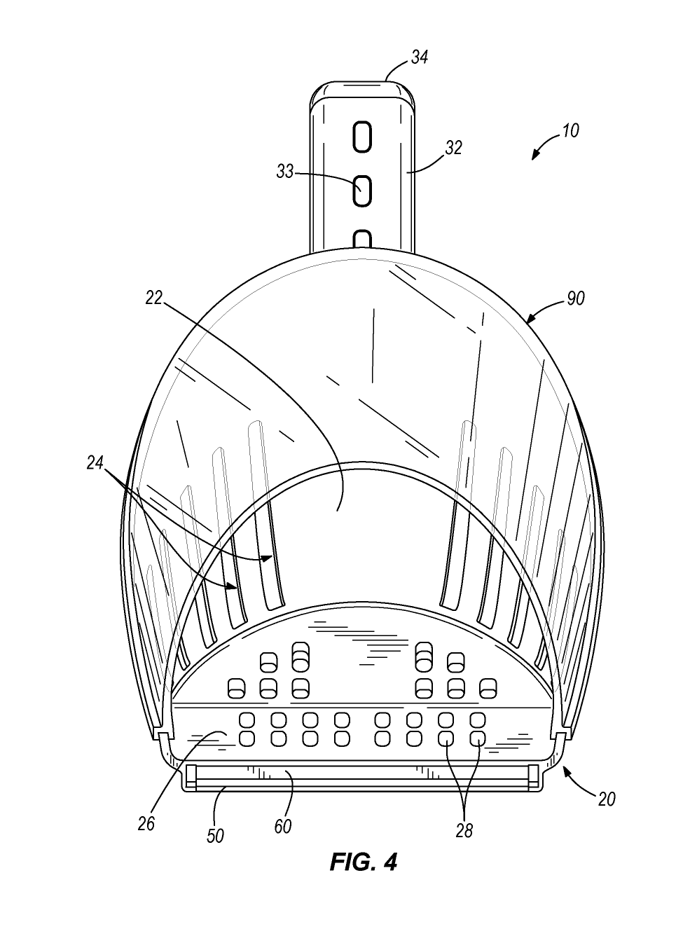

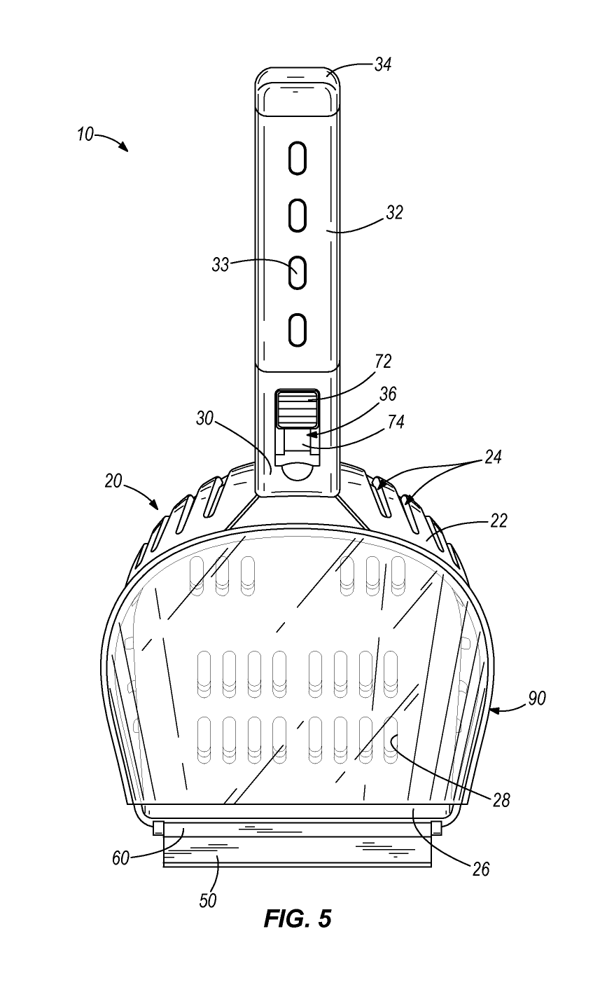

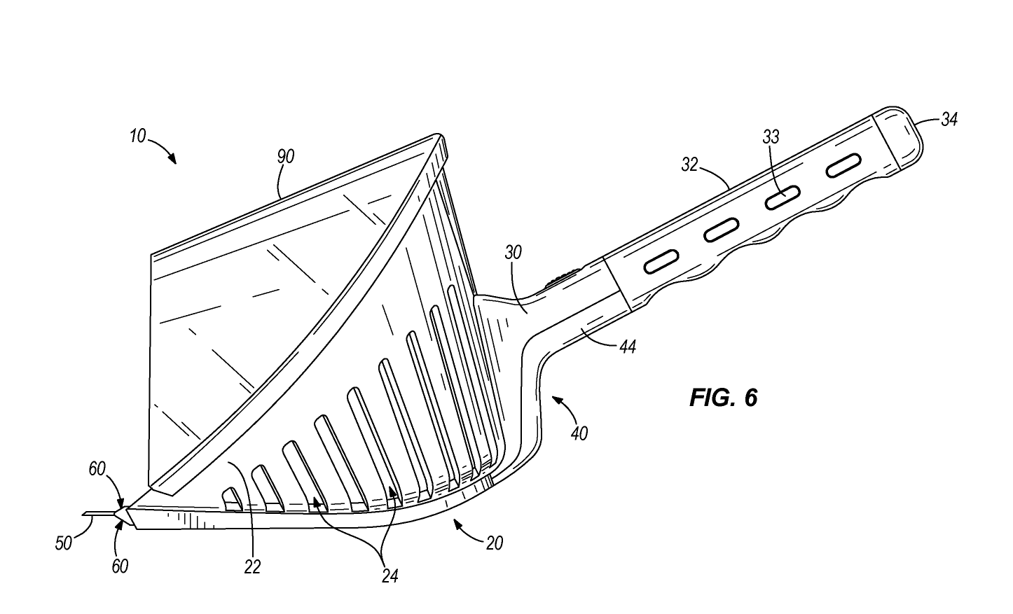

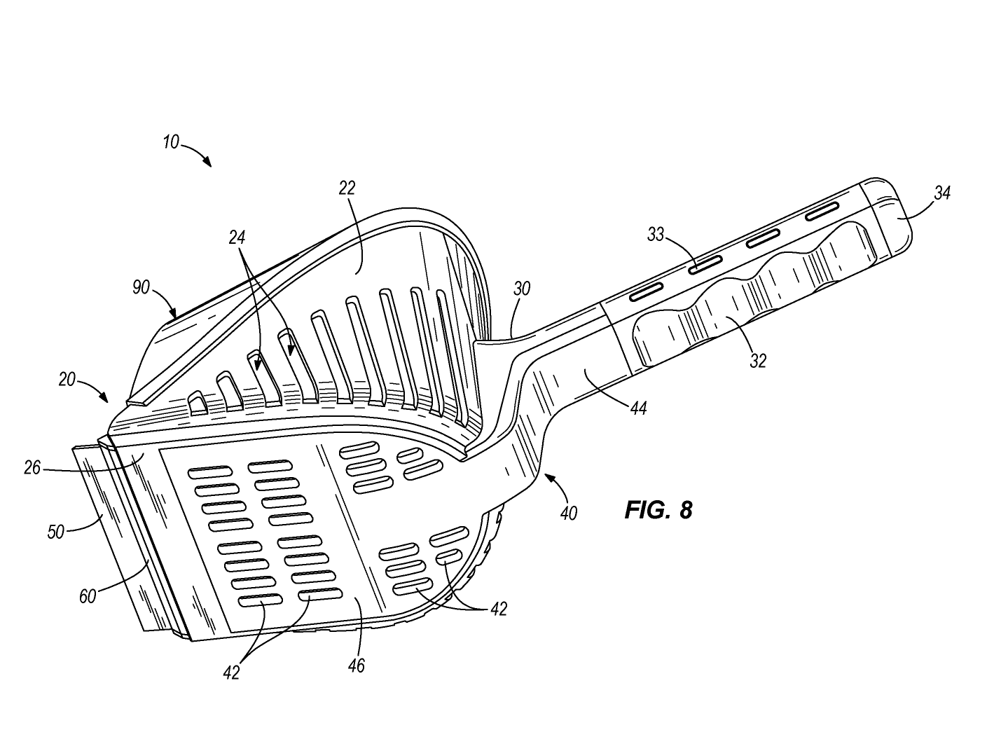

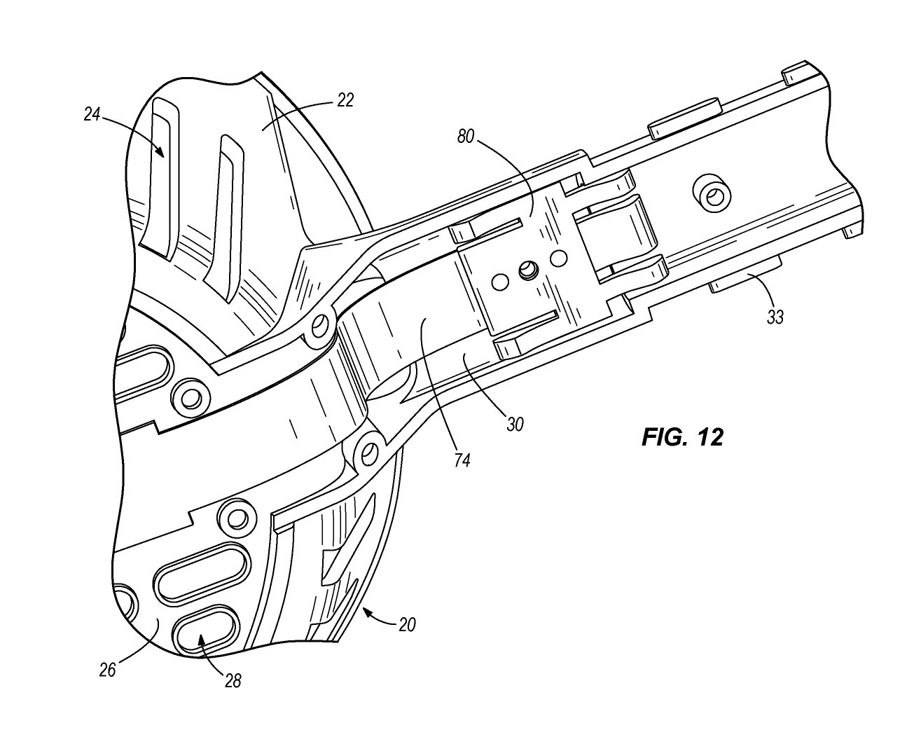

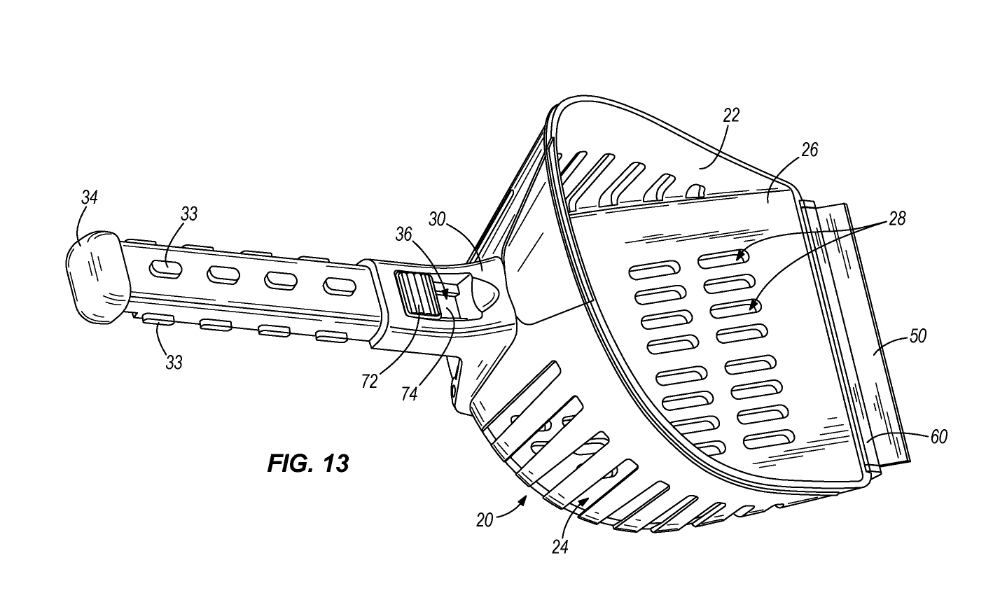

Handle 30 extends from the back surface of side wall 22 and is generally perpendicular to side wall 22. In this example, handle 30 is formed integrally with side wall 22, however, handle 30 could be a separate part that is secured to side wall 22 by any well known means such as adhesive, screws, nuts and bolts, rivets, etc. As can be seen in FIGS. 1-10 and 12-13, in one example handle 30 has multiple protrusions 33 formed on the outside surface, which are positioned such that they pass through holes formed in grip 32, as described in more detail below. Alternatively, protrusions 33 are not necessary if grip 32 does not have holes to receive the protrusions 33. In addition, if no grip is used, the outside surface of handle 30 could be formed with a shape and texture to provide a comfortable grip for the user. Aperture 36 is formed through handle 30 and is positioned proximate side wall 22 such that switch 72 protrudes through aperture 36, as described in more detail below.

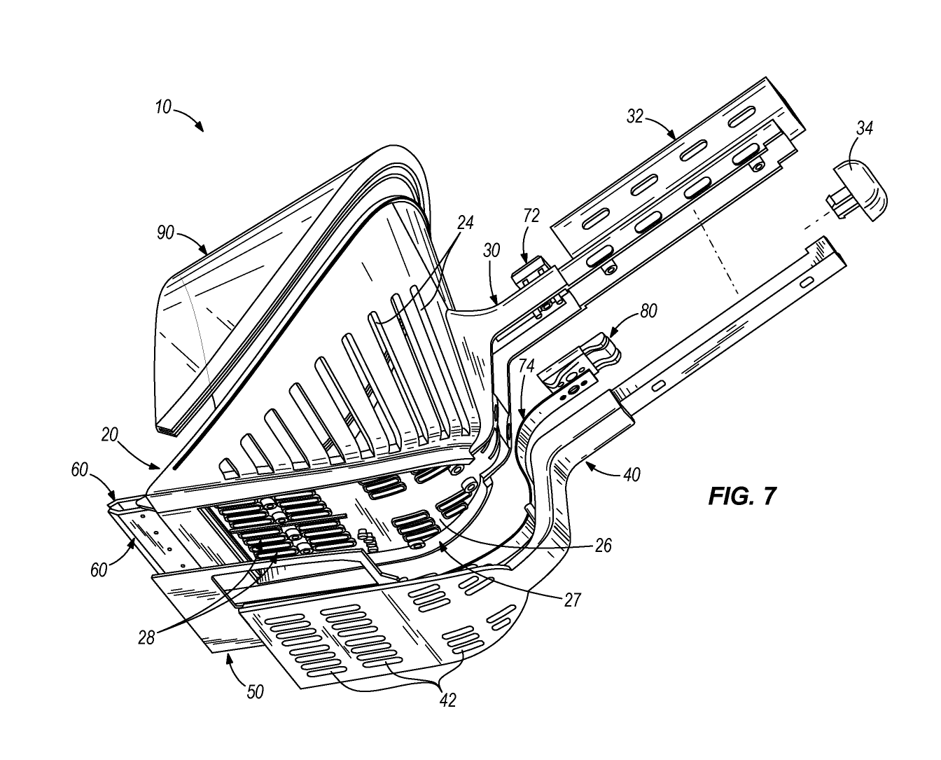

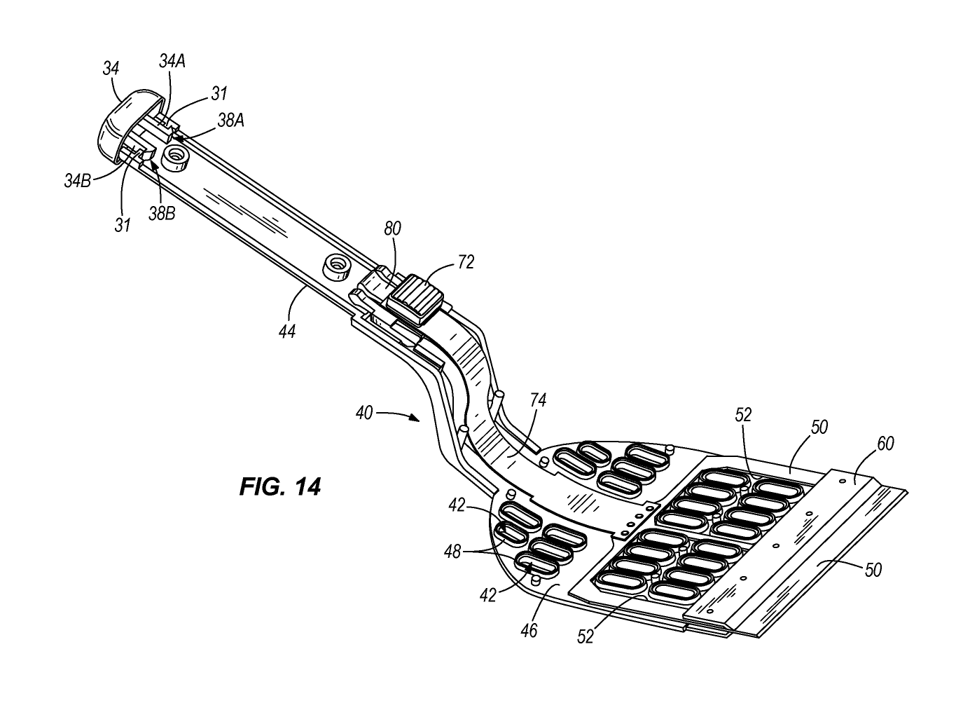

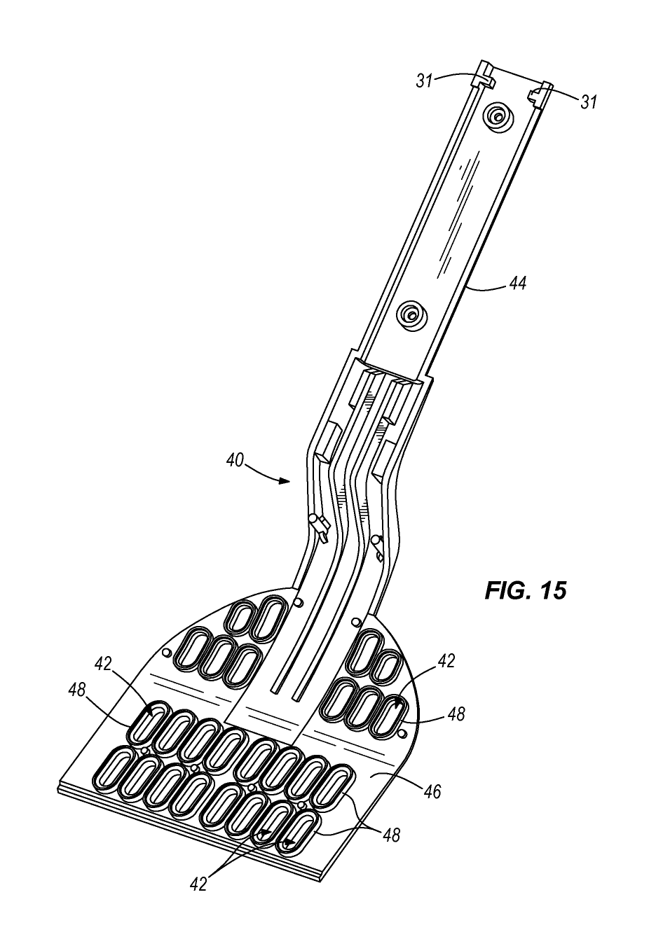

Referring to FIGS. 7, 8, and 14-16, back plate 40 has integrally formed first portion 44 and second portion 46. First portion 44 of back plate 40 mates with handle 30 and the back surface of side wall 22 to form a passage for strip 74 and can be secured to handle 30 and the back surface of side wall 22 through an interference or snap fit or can be secured by an adhesive or other well known method such as sonic welding, heat staking, etc. Second portion 46 of back plate 40 mates with the bottom surface of bottom wall 26 to form the cavity 27 in which strip 74 and a portion of blade 50 move and can be secured to bottom wall 26 through an interference or snap fit or can be secured by an adhesive or other well known method such as sonic welding, heat staking, etc. Second portion 46 also has slots 42 to allow the passage of debris, which are aligned with and generally have the same width and length dimensions of slots 28 in bottom wall 26. Raised walls 48 (see FIGS. 14 and 15) are formed on the inside surface of second portion 46 around slots 42 to prevent debris passing through slots 28 and 42 from entering the cavity 27 formed by second portion 46 and bottom wall 26. The height of walls 48 is such that the top surface of walls 48 is adjacent the bottom surface of bottom wall 26 so that litter and other debris cannot pass between.

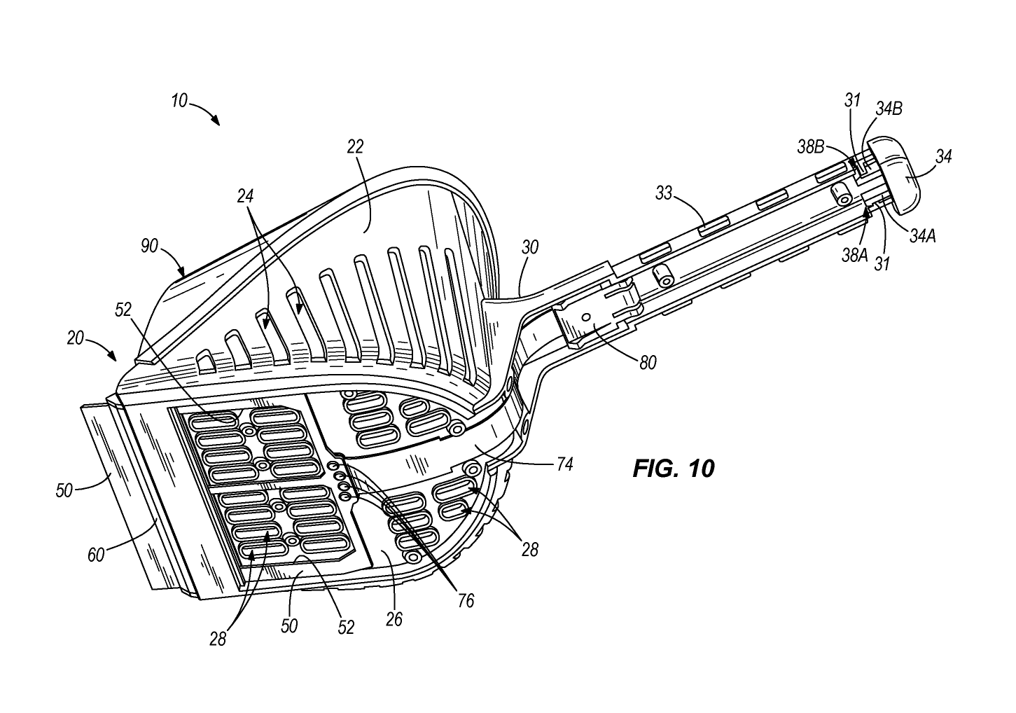

End cap 34 is secured to the ends of handle 30 and back plate 40, opposite basket 20 to cover the cavity formed by handle 30 and back plate 40. As can best be seen in FIGS. 10 and 14, in the example shown, end cap 34 has a pair of arms 34A and 34B, each having a latch member 38A and 38B at the end. When end cap 34 is inserted into the cavity formed by handle 30 and back plate 40, latch members 38A and 38B engage shoulders 31 formed in handle 30 and shoulders 31 formed in back plate 40 and handle 30 to secure end cap 34.

Grip 32 is placed over handle 30 and first portion 44 of back plate 40 to provide a soft and comfortable surface for the user. Alternatively, if desired, grip 32 may not be used at all. Referring to FIGS. 1-3, 6, and 8, one example of grip 32 is shown. In this example, grip 32 is made of thermoplastic elastomer (TPE), has a generally flat surfaces on the top and sides, and has an undulating surface on the bottom, which provides a more comfortable surface for the fingers of the user. In addition, the top and side surfaces of grip 32 have holes formed therein to receive protrusions 33 in handle 30, which assist in keeping grip 32 in place. Referring to FIG. 18, another example of grip 32′ is shown. In this example, grip 32′ is also made of TPE and may or may not have an undulating surface on the bottom. However, in this example the top and side surface of grip 32′ have multiple nubs formed on the outside surface to provide a non-slip grip for the user. In addition, the top and side surfaces do not have holes formed therethrough.

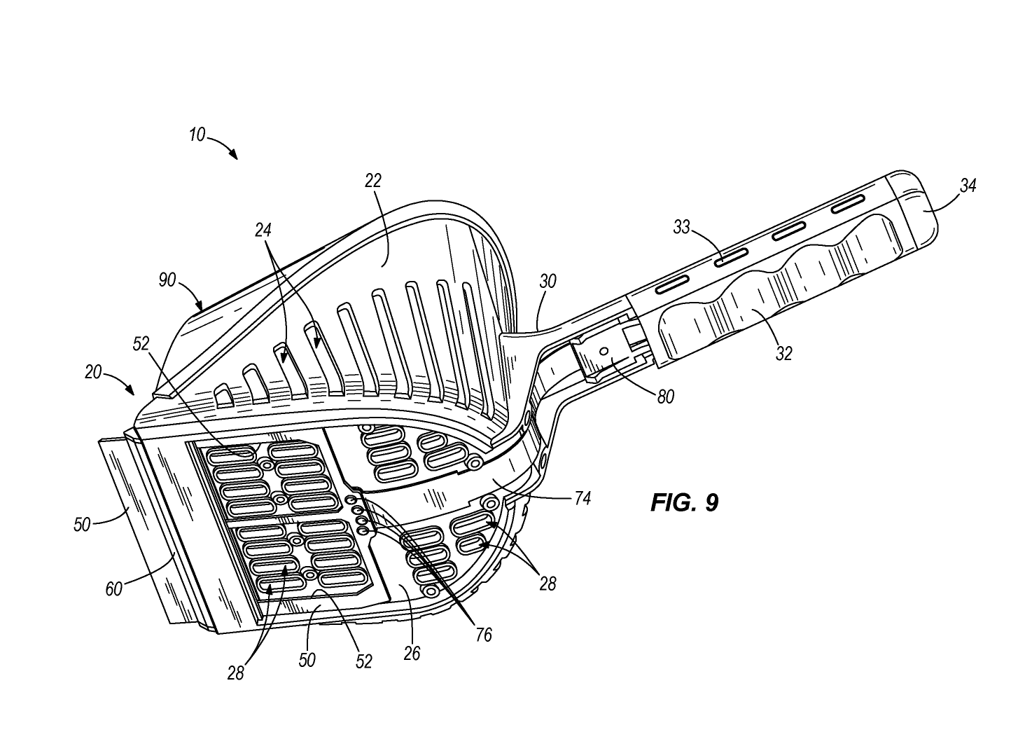

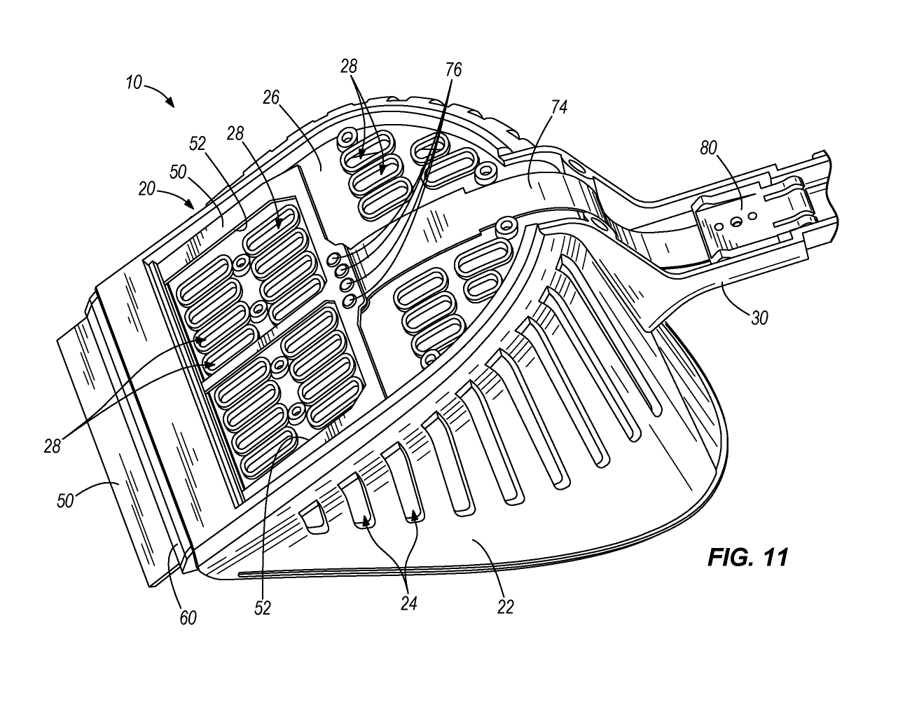

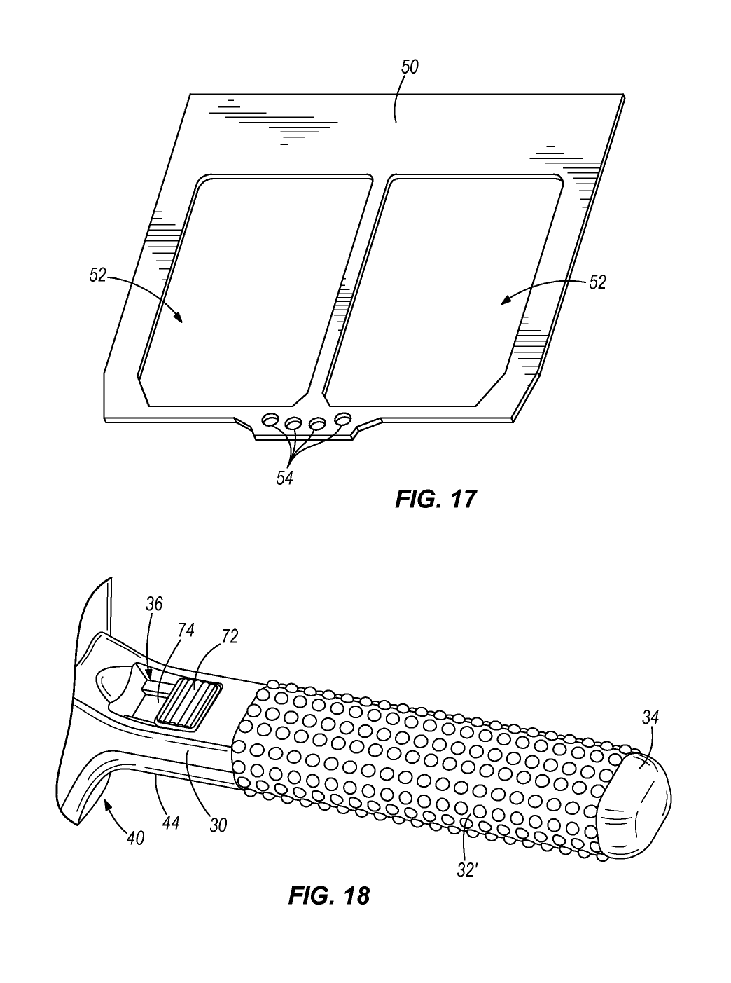

Referring to FIGS. 7, 9-11, and 17, one example of blade 50 is shown. In this example, blade 50 is generally rectangular and is made from 1.0 mm thick stainless steel, but could be made of other shapes and materials as desired. Apertures 52 are formed in blade 50, which allow blade 50 to extend and retract within cavity 27 without blocking slots 28, 42 in bottom wall 26 and second portion 46 of back plate 40 or interfering with raised walls 48 of back plate 40. In this example, apertures 52 are generally rectangular, but could be any shape required. Holes 54 are also formed in blade 50 and are adapted to receive posts 76 to connect blade 50 to flexible strip 74 (see e.g. FIGS. 9 and 10). Alternatively, blade 50 could be connected to flexible strip 74 in any manner desired, such as by welding, adhesive, rivets, etc.

Referring to FIGS. 9-11, blade 50 is disposed within the cavity 27 formed between bottom wall 26 and back plate 40, and is moveable within the cavity 27 such that blade 50 can extend from and retract into the cavity 27. In the extended position, blade 50 can be used to cleanly break the bond between wet, sticky clumps of litter and the bottom or sides of the litter box. This allows for thorough scraping of debris from the surfaces of the litter box leaving the litter box cleaner and also reduces the offensive urine odor and the potential risk of exposing the animal to the growth of harmful bacteria.

In this example, cleaning plates 60 are positioned within cavities formed in the front edge of bottom wall 26 and extend from the front edge of bottom wall 26, on opposite sides of blade 50. Cleaning plates 60 are made of 1.0 mm thick stainless steel, and are secured in the cavities by an adhesive. Alternatively, cleaning plates 60 could be made of any material desired and could be secured to the front edge of bottom wall 26 by any well know methods, such as with posts that extend through holes in bottom wall 26 and cleaning plates 60 or by molding cleaning plates 60 into bottom wall 26. In addition, rather than being separate parts, cleaning plates 60 could be integrally molded with bottom wall 26.

Cleaning plates 60 are generally parallel to bottom plate 26 as they extend from bottom plate 26 and angle inward toward blade 50 as they extend further away from bottom plate 26, such that the distal edge of cleaning plates 60 are adjacent the top and bottom surfaces of blade 50. This allows cleaning plates 60 to scrape clean blade 50 when blade 50 is retracted. As blade 50 is retracted into the cavity in bottom plate 26, the distal edges of cleaning plates 60 run along the surfaces of blade 50 and scrape off the debris that may be accumulated on the surfaces of blade 50.

An actuator assembly is used to extend and retract blade 50 and in this example is generally formed by switch 72, flexible strip 74, and locking member 80. In this example, flexible strip 74 is made of stainless steel and is approximately 125 mm long, switch 72 is made of ABS and TPE in a co-injection process, and locking member 80 is made of Nylon. Referring to FIGS. 7, 9-12, 14, and 16, one end of flexible strip 74 is connected to blade 50 by posts 76, which extend through holes in flexible strip 74 and blade 50. Flexible strip 74 then extends between basket 20 and back plate 40 towards handle 30 and past aperture 36 in handle 30. Switch 72 and locking member 80 are secured to flexible strip 74 such that switch 72 is generally aligned with and extends into aperture 36. In this example, flexible strip 74 and locking member 80 have holes that are adapted to receive posts or other protrusions formed on the bottom side of switch 72. Flexible strip 74 and locking member 80 are then secured through a snap fit, adhesive, heat staking, etc. The actual parts used for the actuator assembly are not critical, so long as movement of the exposed switch translates into movement of blade 50. For example, switch 72 and locking member 80 could be one single part that connects to flexible strip 74, rather than the two separate parts shown. In addition, if locking the switch 72 and blade 50 in place is not required or desired, locking member 80 is not required.

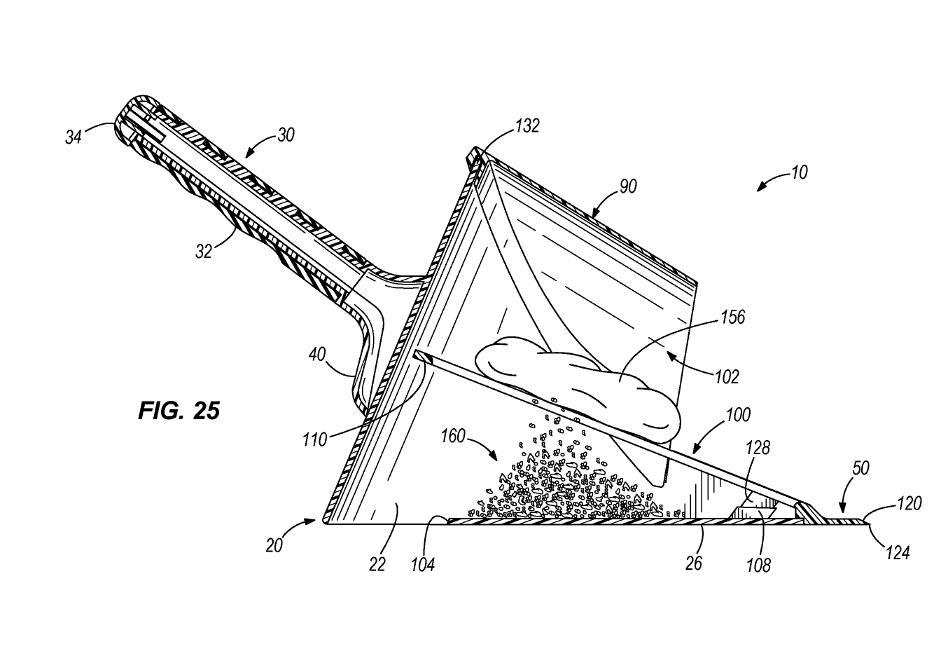

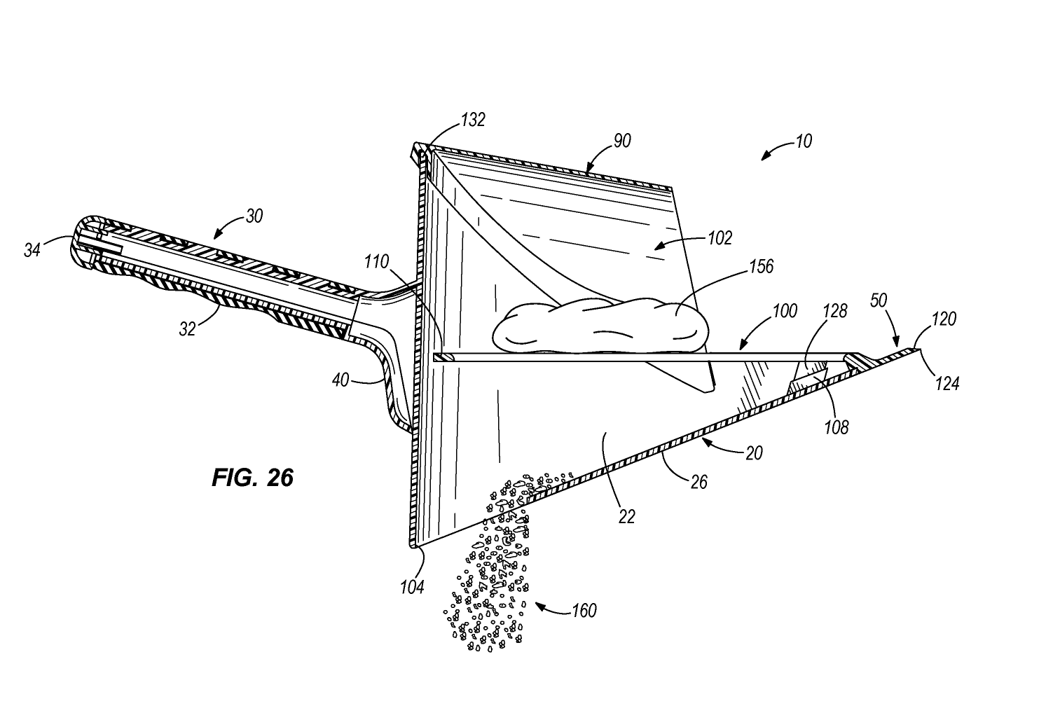

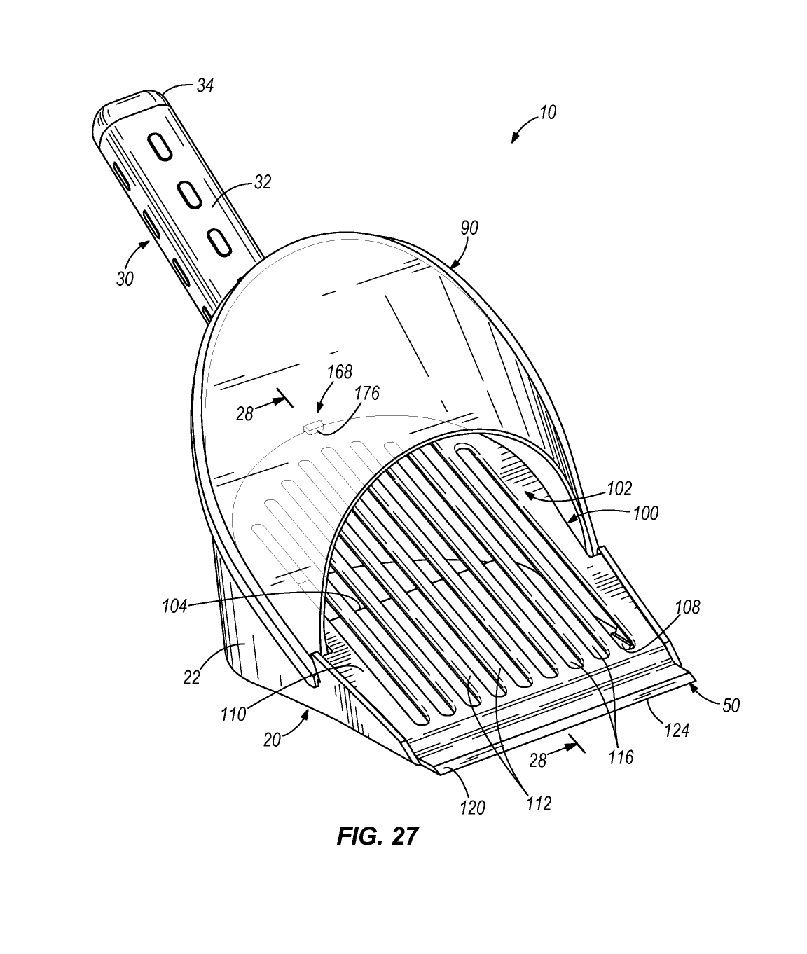

Referring to FIGS. 1 and 3-10, litter box cleaning device 10 can also have a cover or hood 90, which can be used to reduce the amount of airborne dust that the user can possibly inhale due to the movement of the litter and the billowing dust that normally arises from a litter box during scooping. Hood 90 also assists in preventing soiled litter from falling back on the user's hand while scooping. In this example, hood 90 has a generally curved shape and is made from a translucent or transparent material such as, for example, polycarbonate, which allows the user to visualize the scooping process. Alternatively, the hood 90 could be made of other materials as long as the hood 90 is sufficiently translucent to allow a user to view through the hood 90 and see within the basket 20. In addition, in this example hood 90 is removably connected to the edge of side wall 22. This can be done through the use of an interference fit (e.g., see FIG. 26) between side wall 22 and hood 90, a snap fit (e.g., see FIG. 25), or any other well known manner. Alternatively, hood 90 could also be secured to basket 20 through other well known means such as by use of an adhesive, by sonic welding, etc. such that hood 90 would not be removable from basket 20.

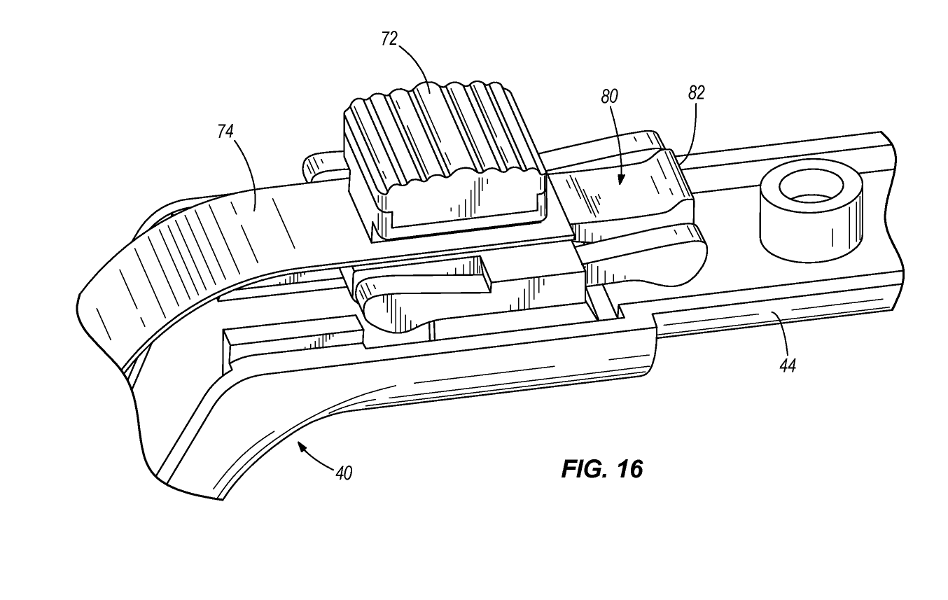

In use, to extend blade 50, the user pushes switch 72 down and forward (toward the basket 20). Switch 72 is connected to strip 74, therefore as switch 72 is moved forward strip 74 also moves. As strip 74 is moved in a forward direction with the switch 72, strip 74 slides within the cavity 27 between basket 20 and back plate 40 such that the end of strip 74 that is connected to blade 50 also moves forward, toward the front of basket 20. This movement of strip 74 towards the front of basket 20 also pushes blade 50 forward, which extends blade 50 such that it extends past cleaning plates 60. When switch 72 reaches its forward position, catch member 82 (see FIG. 16), formed on locking member 80, engages a cavity formed in the bottom surface of handle 30. As a result of this engagement, pressure exerted on blade 50, and therefore on flexible strip 74, as it is used to scrape debris in the litter box will not cause blade 50 to retract since the engagement of catch member 82 in the cavity in handle 30 will prevent movement of switch 72. With blade 50 in an extended position, the user can use device 10 to scrape the sides and bottom of a litter box by running the edge of blade 50 along the side or edge of the litter box.

To retract blade 50, switch 72 is depressed to disengage catch 82 from the cavity in handle 30. The user then pulls switch 72 back (away from basket 20), which in turn moves strip 74 back. As strip 74 moves backwards with switch 72, strip 74 slides between basket 20 and back plate 40 such that the end of strip 74 that is connected to blade 50 also moves backward, away from the front of basket 20. This movement of strip 74 away from the front of basket 20 pulls blade 50 back, which retracts blade 50 such that it is retracted between cleaning plates 60 until the front edge of blade 50 is behind the front edges of cleaning plates 60. As blade 50 is being retracted between cleaning plates 60, the distal edges of cleaning plates 60 scrape residue from the surfaces of blade 50.

To assemble device 10, if cleaning plates 60 are separate pieces as shown in the examples herein, cleaning plates 60 are inserted into the front edges of bottom wall 26 and secured. Blade 50 is connected to one end of strip 74 with posts 76 and switch 72 and locking member 80 are connected near the opposite end of strip 74. Alternatively, strip 74 could be connected to blade 50 in other well known ways, such as through an adhesive, sonic welding, heat staking, etc. In addition, switch 72 can be connected to strip 74 and locking member 80 in any well known manner as well. Blade 50 is then inserted into the cavity 27 between bottom wall 26 and back plate 40, and strip 74 is positioned along the outside surfaces of bottom wall 26 and side wall 22 such that switch 72 is aligned with and protrudes through aperture 36 in handle 30. If handle 30 were a separate part, rather than being integrally molded with basket 20, handle 30 would also need to be connected to basket 20.

Back plate 40 is secured to basket 20 and handle 30 through an interference or snap fit or can be secured by an adhesive or other well known method such as sonic welding, heat staking, etc. If a grip is used, grip 32 is positioned over handle 30 and back plate 40. In one example shown herein, grip 32 is aligned such that holes in grip 32 are aligned with protrusions 33 formed in handle 30, which assists in preventing grip 32 from moving during use. End cap 34 is connected to the ends of handle 30 and back plate 40, which covers the cavity formed by handle 30 and back plate 40 and assists in keeping grip 32 in place, if used.

Hood 90 is connected to the edge of side wall 22. If hood 90 is removable, hood 90 could be connected by means of an interference or snap fit, or other well known means. If hood 90 is not removable, hood 90 could be connected through an adhesive, heat staking, sonic welding, etc.

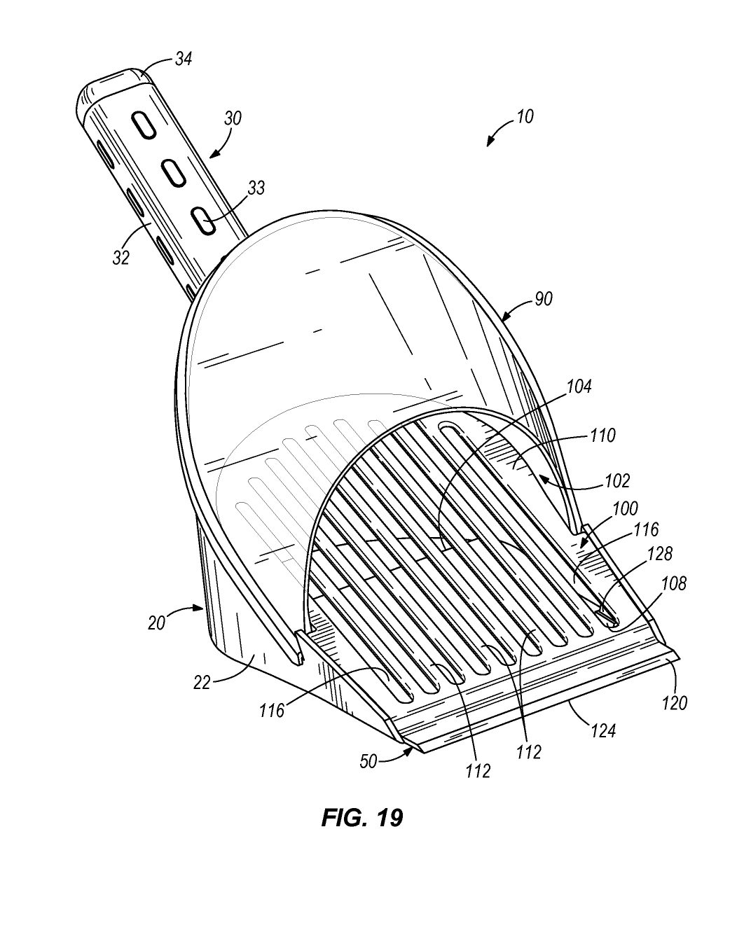

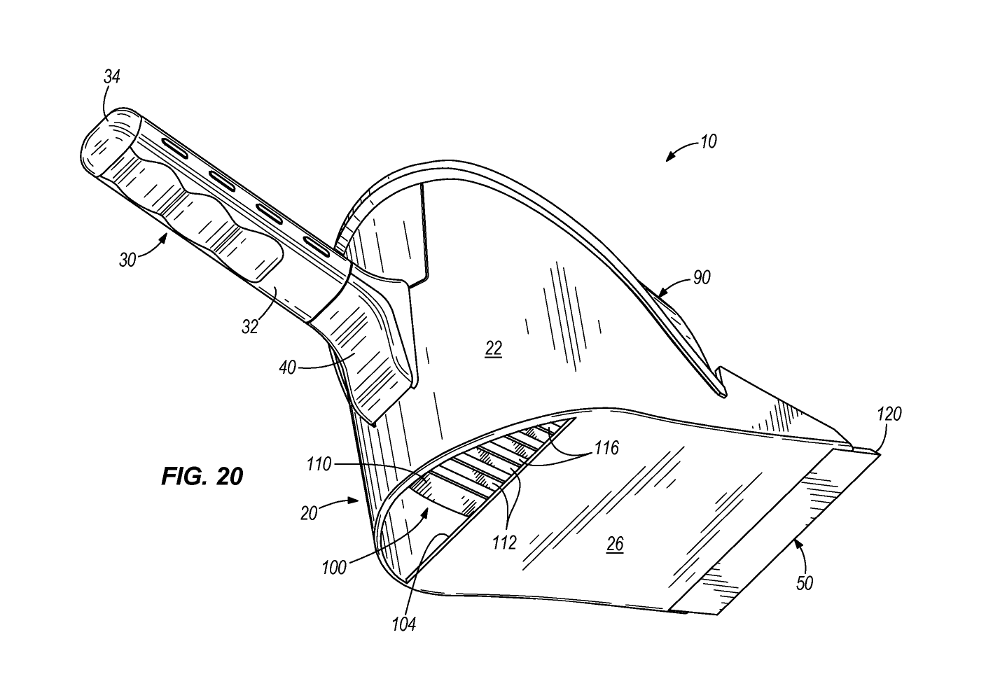

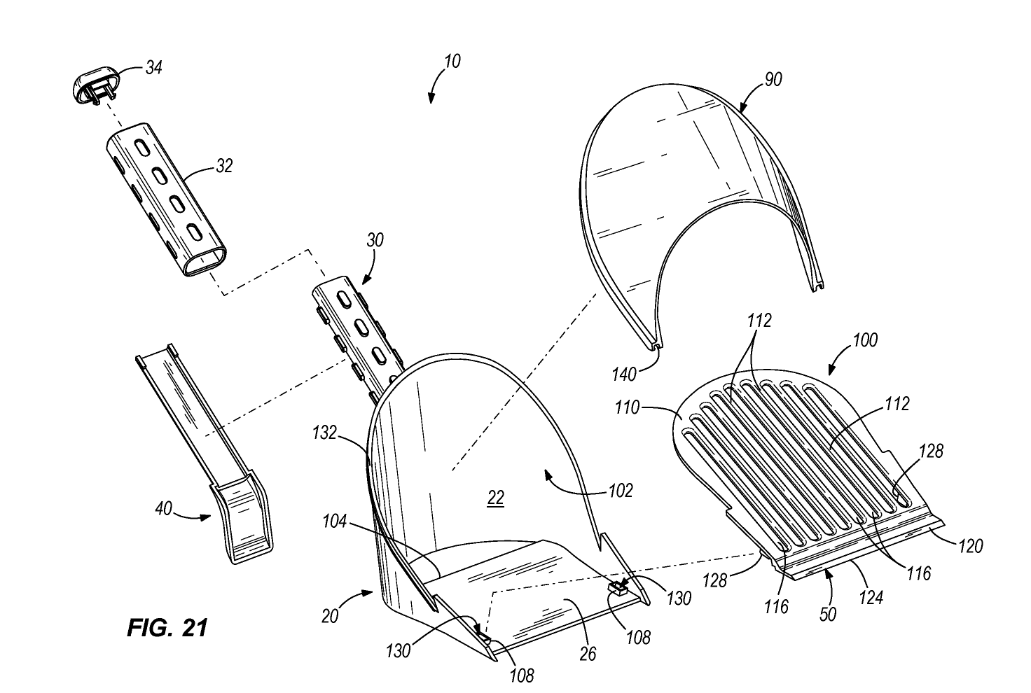

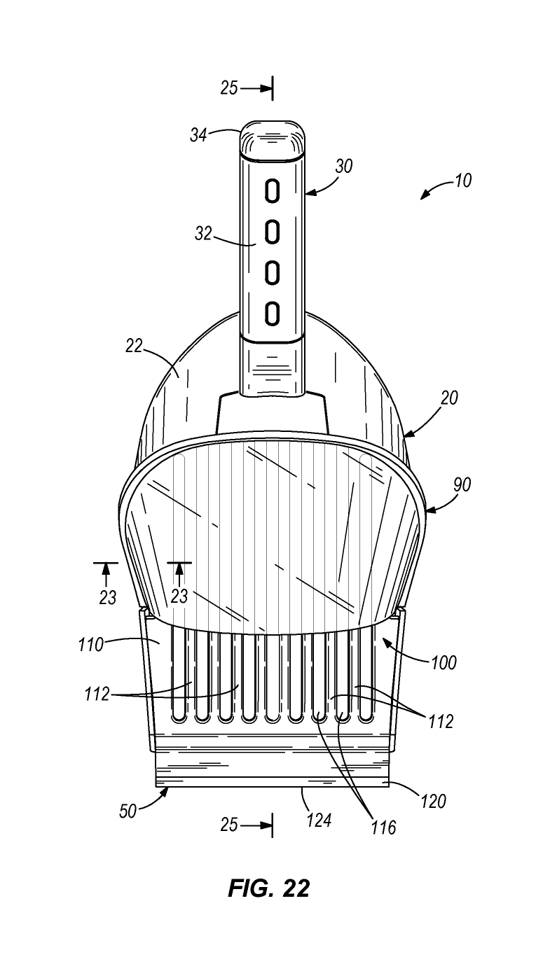

Referring now to FIGS. 19-26, another example of a litter box cleaning device is illustrated. The embodiment of the device illustrated in FIGS. 19-26 has some similarities to the embodiment of the device illustrated in FIGS. 1-18 and such similarities between the two embodiments will be identified herein with similar reference numbers.

With particular reference to FIGS. 19-22, the litter box cleaning device 10 includes a basket 20, a handle 30, a grip 32, an end cap 34, a back plate 40, a translucent or transparent hood 90 connected to the basket 20, and a filter 100 connected to the basket 20. The handle 30, grip 32, end cap 34, and back plate 40 of the second embodiment are substantially similar in structure and function to their counterparts in the first embodiment and therefore will not be described again herein. The basket 20 includes a side wall 22 and a bottom wall 26 that together form a scooping receptacle 102 for scooping litter and debris present in the litter. An aperture 104 is defined in the bottom wall 26 of the basket 20 and the purpose of which will be described in greater detail below. The basket 20 also includes a pair of support members 108 for assisting with connection of the filter 100 to the basket 20 (described in greater detail below). In the illustrated example, the basket 20 includes a pair of support members 108. In other examples, the basket 20 may include any number of support members 108 to assist with connecting the filter 100 to the basket 20.

With continued reference to FIGS. 19-22, the filter 100 assumes a complimentarily shape to the shape of the scooping receptacle 102 defined by the basket 20. In the illustrated example, the filter 100 is a one-piece unitarily formed component including a scraper blade 50 and a body 110 extending at an upward obtuse angle from the blade 50. In other exemplary embodiments, the filter 100 may comprise multiple components fastened, bonded, or otherwise secured together to form the filter 100. In the illustrated example, the body 110 extends from the blade 50 at about 160° degree angle from the blade 50. In other exemplary embodiments, the body 110 may extend from the blade 50 at angles between about 140° and 170°. Alternatively, the body 110 may extend from the blade 50 at a variety of other angles. In further exemplary embodiments, the filter 100 could also be secured to basket 20 through other well known means such as by use of an adhesive, by sonic welding, etc. such that filter 100 would not be removable from basket 20. Also, in additional exemplary embodiments, the filter 100 may be unitarily formed as one-piece with the basket 20.

The blade 50 is used to assist with scraping clumped litter and debris from side walls and a bottom of a litter box. The blade 50 has an angled surface 120 that provides a sharp leading edge 124 to facilitate easier scraping of clumped litter and debris from the litter box. The body 110 includes alternating pluralities of bars 112 and slots 116 that in combination facilitate passage of relatively small, clean, and unclumped particles of litter through the filter 100 and prevent passage of relatively large, used, clumped particles of litter and debris through the filter 100. In other examples, the body 100 may include bars 112 and slots 116 arranged in non-parallel manners, or may include a variety of different configurations of slots, apertures, or other types of voids therein as long as the filter 100 is capable of filtering or separating particles in the desired manner.

In the illustrated example, the filter 100 further includes a pair of protrusions 128 depending downward from a bottom surface of the body 110. The protrusions 128 insert into the support members 108 of the basket 20 to assist with securing the filter 100 to the basket 20. In some embodiments, the protrusions 128 are secured within the support members 108 via an interference-fit or friction-fit. In such embodiments, a receptacle 130 of the support members 108 and the protrusions 128 of the filter 100 are complimentarily shaped such that the protrusions 128 are forced into the receptacles 130 and compressed by interior walls of the receptacle 130. The compression force on the protrusions 128 is sufficient to inhibit removal of the protrusions 128 from the support members 108 during normal operation of the litter box cleaning device 10, but also allow removal of the protrusions 128 from the support members 108 when desired by a user. In other embodiments, the protrusions 128 are secured within the support members 108 in a positive locking manner such as, for example, a snap-fit, actuatable locking mechanism, or any other positive locking manners. In other exemplary embodiments, the filter 100 can include other numbers of protrusions 128 and other numbers of support members 108 in order to removably secure the filter 100 to the basket 20.

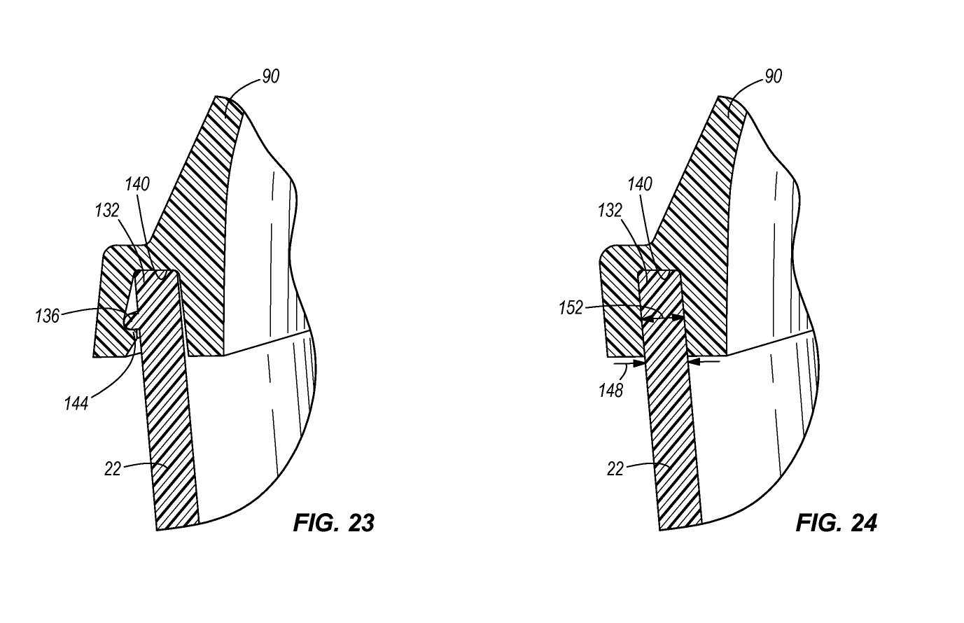

Referring now to FIGS. 23 and 24, the illustrated example of the hood 90 is removably connected to the basket 20 and may be removably connected in a variety of manners. In some exemplary embodiments, the hood 90 is positively connected to a top edge 132 of the basket side wall 22 (see FIG. 23). In such embodiments, the top edge 132 of the side wall 22 includes a projection or lip 136 and the hood 90 includes a complimentarily shaped recess 140 and lip 144. To connect the hood 90 in such embodiments, the recess 140 is aligned with the top edge 132 of the side wall 22 and the hood 90 is moved downward toward the top edge 132 such that the lip 136 of the top edge 132 inserts into the recess 140 of the hood 90, outwardly deflects the lip 144 of the hood 90, and the lip 144 returns toward or to its non-deflected position upon passing the lip 136 of the top edge 132 to position the hood lip 144 underneath the top edge lip 136 and positively secure the hood 90 to the basket 20. The hood 90 is removed from the basket 20 by outwardly deflecting the hood lip 144 beyond the top edge lip 136 to allow the hood lip 144 to pass by the lip 136 and facilitate removal of the hood 90 from the basket 20. In other exemplary embodiments, the hood 90 is interference-fit or friction-fit to the top edge 132 of the basket side wall 22 (see FIG. 24). In such exemplary embodiments, the recess 140 defined in the hood 90 and the top edge 132 of the side wall 22 are complimentarily shaped such that a width 148 of the top edge 132 is sized slightly wider than an internal width 152 of the hood recess 140. To connect the hood 90 to the basket 20 in such embodiments, the recess 140 is aligned with the top edge 132 of the side wall 22 and the hood 90 is moved downward toward the top edge 132 such that the top edge 132 inserts into the recess 140 and portions of the hood disposed on each side of the recess 140 slightly outwardly deform to accommodate the wider top edge 132 of the side wall 22. As the top edge 132 moves further into the recess 140, a greater interference force is created between the hood 90 and the top edge of the side wall 22 to secure the hood 90 to the basket 20. To remove the hood 90 from the basket 20, the hood 90 is simply pulled straight upward away from the top edge 132 of the side wall 22. In alternative exemplary embodiments, the hood 90 could also be secured to basket 20 through other well known means such as by use of an adhesive, by sonic welding, etc. such that hood 90 would not be removable from basket 20.

Referring now to FIGS. 25 and 26, operation of the litter box cleaning device 10 will be described. When a user desires to clean a litter box by removing debris 156 and clumped litter, the user utilizes the present litter box cleaning device 10. A user grips the handle 30 and leads the device 10 into the litter 160 with the blade 50. The blade 50 is slid underneath the debris 156, thereby causing the debris 156 to slide onto the filter 100 as shown in FIG. 25. The slots 116 in the filter 100 allow loose litter 160 to fall down through the filter 100 and onto the bottom wall 26 of the basket 20, thereby leaving only the debris 156 positioned on the filter 100. The hood 90 is translucent or transparent to allow a user to view therethrough and observe the scooping of the debris 156. In addition, the hood 90 also inhibits the rise of litter dust and other airborne entities that may be detrimental to ones health if inhaled.

After the debris 156 is scooped in the manner described above and illustrated in FIG. 25, the user's next movement is a natural upward tilting of the device 10 such that the blade 50 rises relative to the handle 30 and orients the filter 100 in a substantially horizontal position as illustrated in FIG. 26. This substantially horizontal position maintains the debris 156 on the filter 100 and inhibits it from sliding off of the filter 100. Alternatively, the device 10 can be tilted upward at a more significant angle such that the blade 50 is elevated above the handle 30 and the filter 100 is positioned at a steep angle, thereby sliding the debris 156 to the rear of the filter 100 where it may abut the back wall 22 of the basket 20.

During this natural upward tilting of the device 10, the loose litter 160 supported on the bottom wall 26 of the basket 20 slides along the bottom wall 26 of the basket 20 and falls through the aperture 104 defined in the bottom wall 26. The litter 160 falling from the aperture 104 falls back into the litter box. The configuration of the device 10, and particularly the orientation of the aperture 104 within the device 10, facilitates a relatively small distance for the loose litter 160 to fall back to the litter box, thereby inhibiting the amount of loose litter and litter dust that may become airborne and ultimately become a heath risk if inhaled. Described in another manner, the natural scooping motion of the device 10 enables a user to scoop the debris 156 along with adjacent loose litter 160, maintain the debris 156 in the device 10, and return the loose litter 160 to the litter box relatively quickly from when initially scooped and from a relatively small distance from the top of the litter box.

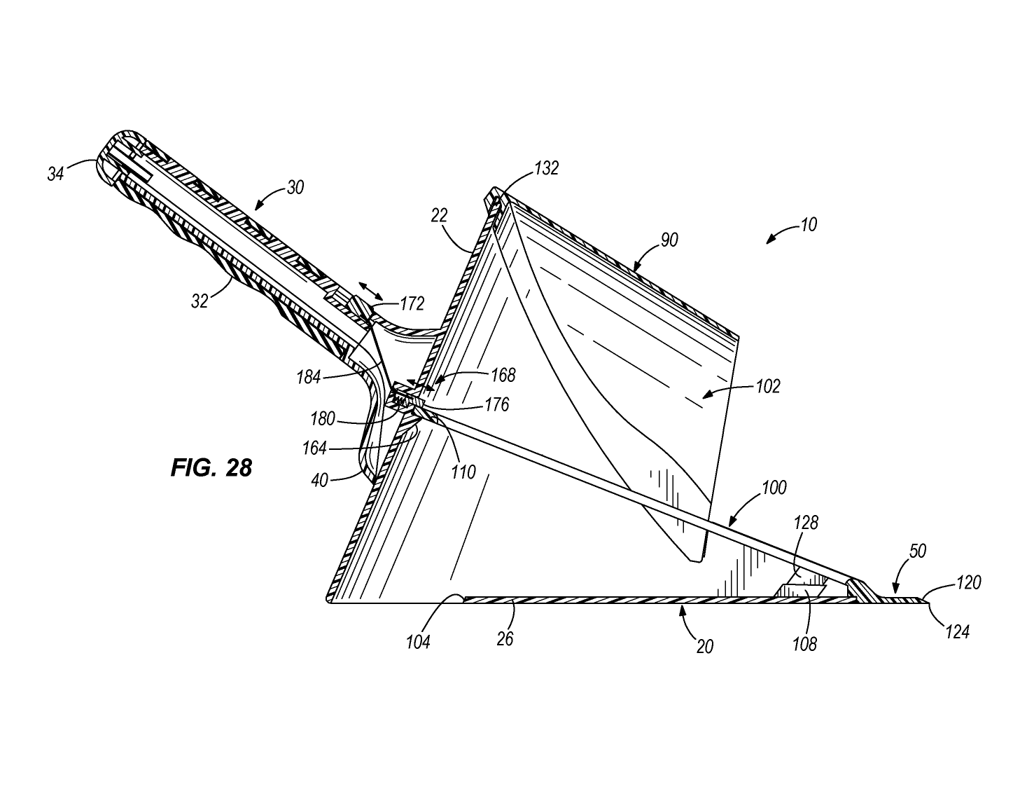

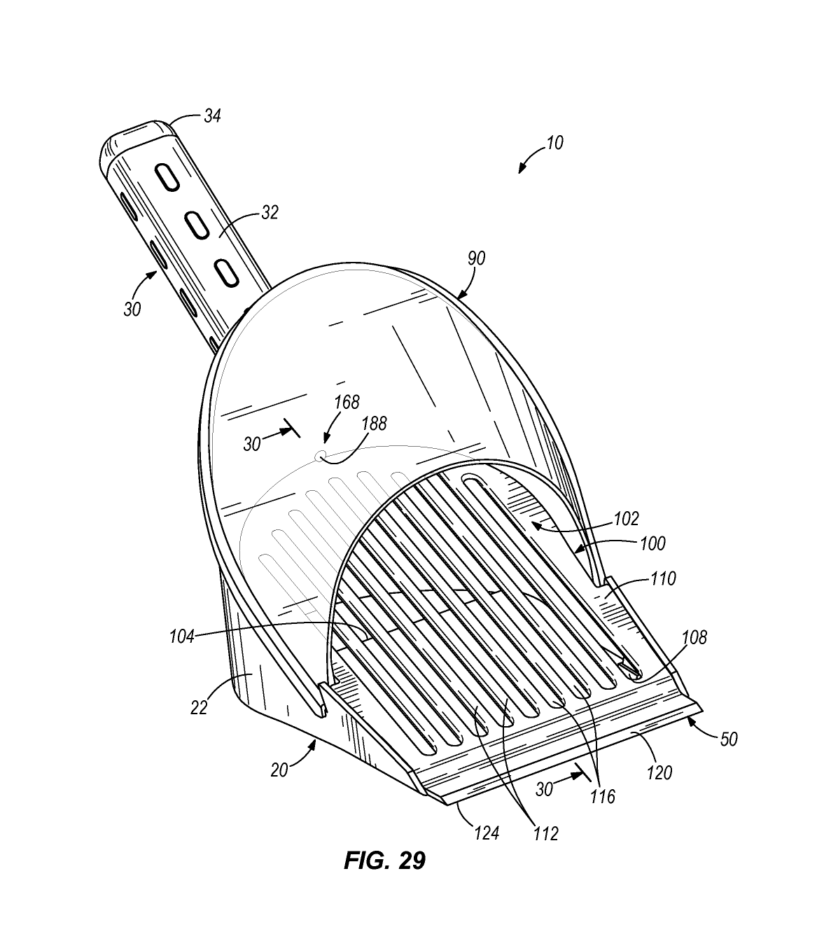

Referring now to FIGS. 27 and 28, an alternative exemplary manner for removably connecting the filter 100 to the device 10 is illustrated. More particularly, the device 10 includes a support shoulder 164 and a locking mechanism 168. The support shoulder 164 extends from the rear wall 22 of the basket 20 and is disposed below the filter 100 such that the filter 100 is supported on the support shoulder 164 when connected to the basket 20. The locking mechanism 168 includes an actuator 172, a movable locking pin 176, a biasing member or spring 180, and a connector 184 for connecting the actuator 172 to the pin 176. In the illustrated exemplary embodiment, the actuator 172 is disposed on a top of the handle 30 and is movable between a locked position and an unlocked position. In other exemplary embodiments, the actuator 172 may be disposed in other locations on the handle 30, on the basket 20, or on other components of the device 10. The locking pin 176 is also movable between a locked position and an unlocked position via the actuator 172 through the connector 184. When the actuator 172 is in the locked position, the locking pin 176 is also in the locked position and when the actuator 172 is in the unlocked position, the locking pin 176 is also in the unlocked position. The spring 180 is operable to force the pin 176 toward the locked position. Accordingly, when the actuator 172 is in the unlocked position and a user releases the actuator 172, the locking pin 176 and the actuator 172 both move to the locked positions under the bias of the spring 180. The locking pin 176 is disposed above the rear of the filter 100 when in the locked position to trap the rear of the filter 100 between the locking pin 176 and the support shoulder 164, thereby inhibiting removal of the filter 100 from the device 10. When the locking pin 176 is in the unlocked position, the pin 176 is moved rearward out from above the rear of the filter 100 to allow the filter 100 to be removed from the device 10. A user can move the locking pin 176 between the locked and unlocked positions as desired to facilitate selective removal of the filter 100. It may be desirable to remove the filter 100 for cleaning purposes or to replace a broken or otherwise malfunctioning filter 100.

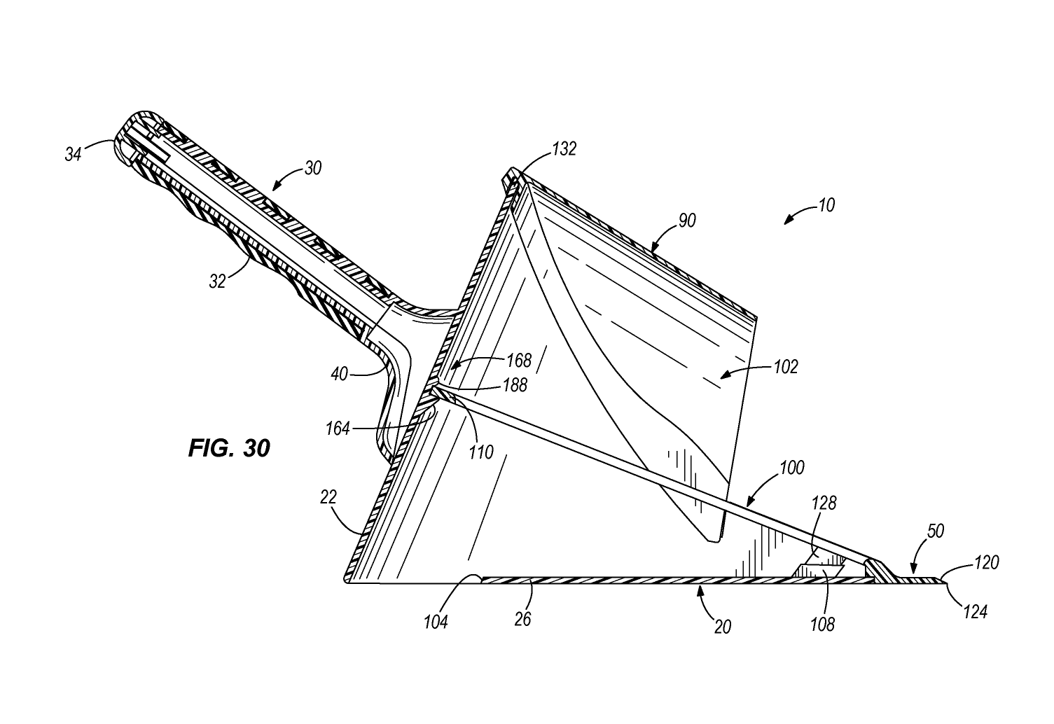

Referring now to FIGS. 29 and 30, an alternative exemplary locking mechanism is illustrated. More particularly, the locking mechanism 168 includes a detent 188 positioned above the support shoulder 164 and above the rear of the filter 100 when the filter is connected to the device 10. In the illustrated exemplary embodiment, the detent 188 is semi-spherical in shape. Alternatively, the detent 188 can have different shapes. To remove the filter 100 from the device 10, a user grips or otherwise engages the filter 100 and applies an upward force on the filter 100 sufficient to slightly elastically deform one or both of the filter 100 and the detent 188, thereby allowing the filter 100 to pass by the detent 188 and be removed from the device 10. To connect the filter 100 to the device, the protrusions 128 are positioned in the support members 108 and a sufficient downward force is applied to the filter 100 to slightly elastically deform one or both of the filter 100 and the detent 188 to allow the filter 100 to pass by the detent 188 and trap the rear of the filter 100 between the support shoulder 164 and the detent 188. Again, it may be desirable to remove the filter 100 for cleaning purposes or to replace a broken or otherwise malfunctioning filter 100.

It should be understood that the filter 100 can be removably connected to the litter box cleaning device 10 in a variety of other exemplary manners and it should be understood that any of the exemplary manners for removably connecting the filter 100 to the device 10 can be used in combination with one another. For example, the filter 100 may be removably connected to the device 10 by combining one of the locking mechanisms 168 shown in FIGS. 27 and 28 or FIGS. 29 and 30, and the interference fit between the protrusions 128 and the support members 108.

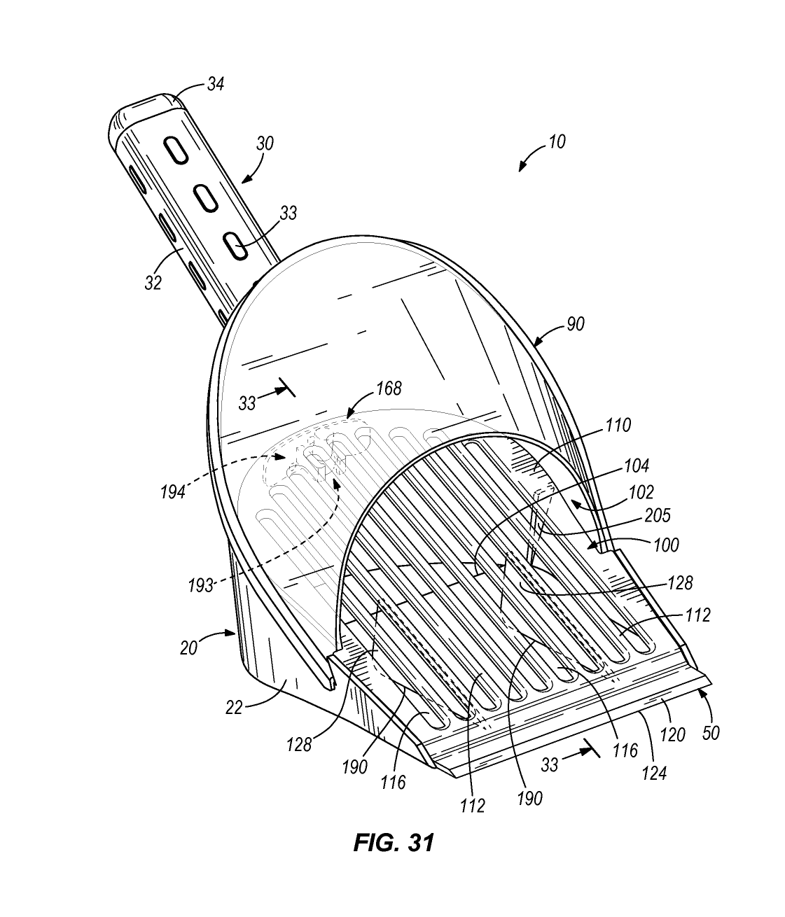

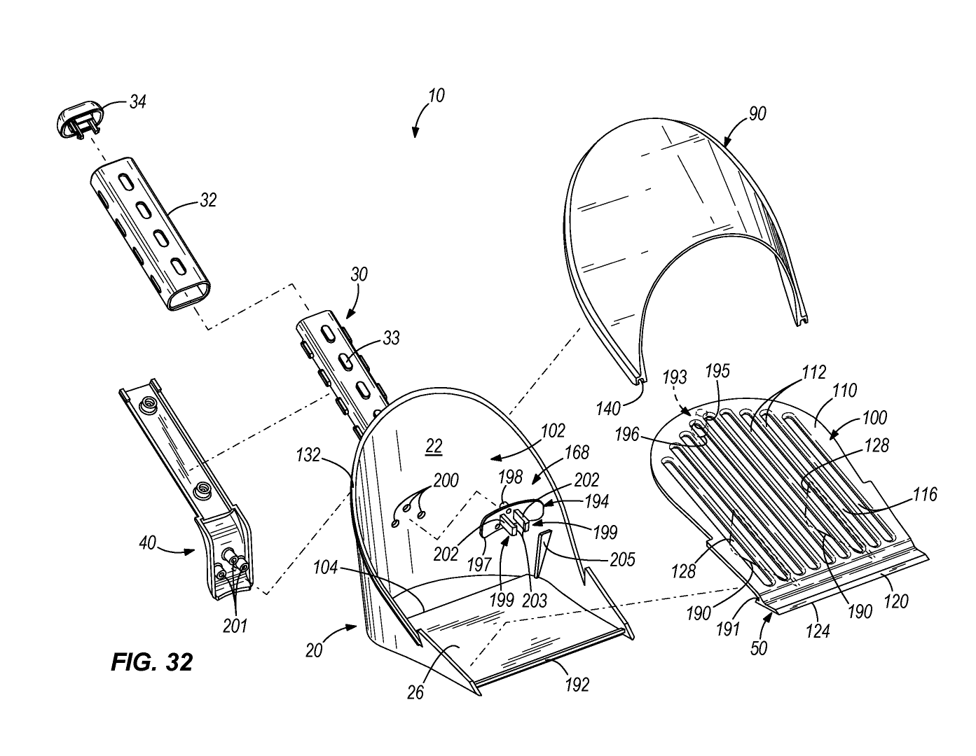

Referring now to FIGS. 31-33, another exemplary litter box cleaning device 10 is illustrated. The embodiment of the device illustrated in FIGS. 31-33 has some similarities to the embodiments of the devices illustrated in FIGS. 1-18 and 19-30 and such similarities between the embodiments will be identified herein with similar reference numbers.

In the illustrated example, the filter 100 includes protrusions 128 that are larger in size than the protrusions 128 illustrated in FIGS. 19-30. The protrusions 128 illustrated in FIGS. 31-33 extend from about the front edge of the body 110 to about half-way up the body 110 and include a bottom edge 190 engageable with the bottom wall 26 of the basket 20 to provide vertical support for the filter 100. Alternatively, the protrusions 128 may extend further or less along the filter body 110 as desired.

With continued reference to FIGS. 31-33, the filter 100 includes a recess 191 defined near a front edge of the body 110 behind the blade 50. The recess 191 is capable of receiving a front edge 192 of the bottom wall 26. This engagement of the front edge 192 with the recess 191 of the filter 100 assists with securing the filter 100 to the basket 20 by inhibiting movement of the filter 100 relative to the basket 20. In some exemplary embodiments, the front edge 192 of the bottom wall 26 merely rests within the recess 191. In other exemplary embodiments, the front edge 192 may be secured within the recess 191 in a variety of manners such as, for example, by an interference-fit or friction-fit, a snap fit, a lip and groove connection, or any other positive locking manner.

The litter box cleaning device 10 further includes a pair of support flanges 205, one extending internally from each side of the side wall 22 of the basket 20 (only one shown). The support flanges 205 extend into the basket 20 below the filter 100. The top surfaces of the support flanges 205 engage an underside of the filter body 110 when the filter 100 is connected to the basket 20 to provide vertical support to filter 100. In the illustrated exemplary embodiment, the support flanges 205 are shaped in a triangular form. However, the support flanges 205 may assume any shape as long as they are disposed below the filter 100 and engage the underside of the filter 100 to provide vertical support to the filter 100.

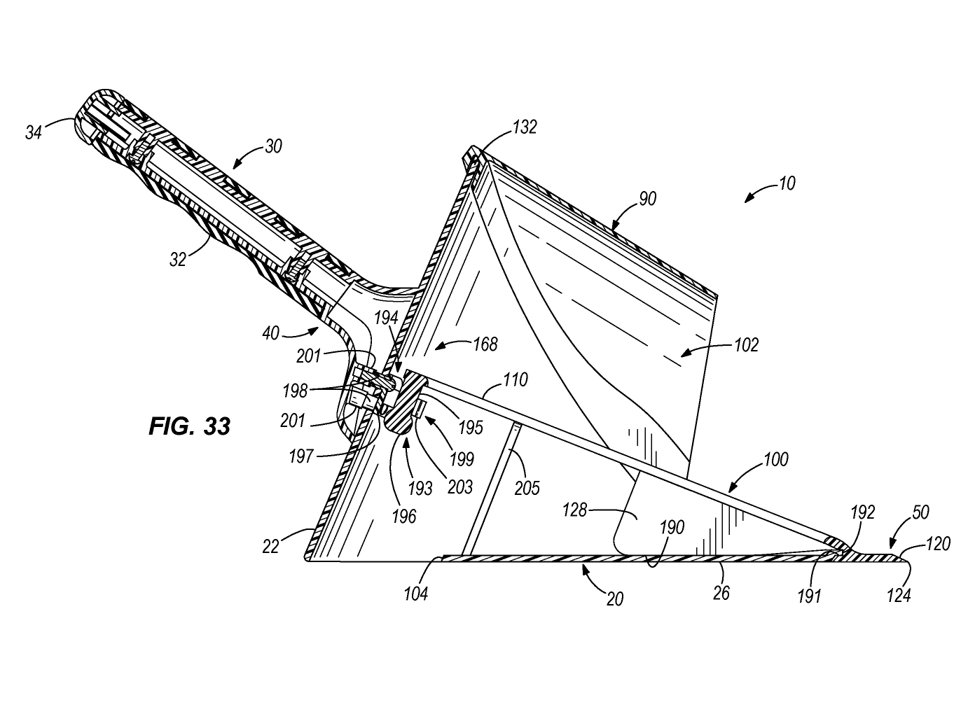

With particular reference to FIG. 33, the back plate 40 is secured to the handle 30 with fasteners. In the illustrated exemplary embodiment, the fasteners are screws and the back plate 40 is screwed to the handle 30. In other exemplary embodiments, the back plate 40 may be secured to the handle 30 with a variety of other fasteners and in a variety of other manners such as, for example, bonding, adhering, etc.

Referring again to FIGS. 31-33, the litter box cleaning device 10 also includes another example of a locking mechanism 168 for removably connecting the filter 100 to the basket 20. The locking mechanism 168 includes a projection 193 extending from a bottom surface of the filter body 110 and a clasp 194 extending into the receptacle 102 defined by the basket 20. The projection 193 includes a stem 195 extending from the bottom surface of the filter body 110 and an enlarged portion 196 at the end of the stem 195. The enlarged portion 196 is larger in size than the stem 195. In the illustrated example, the projection 193 is formed unitarily with the filter body 110. In other exemplary embodiments, the projection 193 may be connected, bonded, or otherwise secured to the filter body 110. The clasp 194 includes a base 197, a plurality of legs 198 extending from a first side of the base 197, and a pair of latching projections 199 extending from a second side of the base 197. The plurality of legs 198 extend through holes 200 defined in the rear wall 22 of the basket 20 and insert into receptacles 201 defined in the back plate 40. The first side of the base 197 engages the interior surface of the rear wall 22. The legs 198 may be secured in the receptacles 201 in a variety of manners such as, for example, interference or friction fit, snap fit, fastened, screwed, or any other positive securing manner. The latching projections 199 extend into the receptacle 102 defined by the basket 20 and include a stem 202 and a flange 203. The stems 202 are spaced a first distance apart from one another and the flanges 203 of the latching projections 199 extend toward each other to provide a second distance therebetween smaller than the first distance. The clasp 194 is made of a resilient material such as, for example, plastic, spring steel, resilient metal, or any other type of material that allows elastic flexibility, and is operable to removably receive the projection 193 from the filter 100 between the latching projections 199. The enlarged portion 196 of the filter projection 193 is wider than the first distance between the latching projections 199.

Operation of the locking mechanism 168 illustrated in FIGS. 31-33 will now be described. As indicated above, the filter 100 is removably connectable to the basket 20. To connect the filter 100 to the basket 20, a user positions the front edge 192 of the bottom wall 26 into the recess 191 defined in the filter 100 and aligns the filter projection 193 between and above the latch projections 199. Then, the filter 100 is moved downward such that the enlarged portion 196 of the filter projection 193 engages both stems 202 of the latch projections 199 and biases the stems 202 away from one other to allow the enlarged portion 196 to pass by the stems 202 to a position below the stems 202. Upon the enlarged portion 196 passing by and below the stems 202, the elasticity of the stems 202 returns the stems 202 toward their original positions. With the stems 202 in or near their original unbiased positions, the enlarged portion 196 of the filter projection 193 is trapped below and inhibited from moving upward by the stems 202. Also, the second distance between the flanges 203 of the latch projections 199 is narrower than the width of the stem 195 of the filter projection 193, thereby inhibiting forward movement of the filter projection 193 toward a front of the device 10. Accordingly, the clasp 194 removably connects the filter 100 to the basket 20 and inhibits disconnection of the filter 100 from the basket 20 during normal operating conditions of the device 10. When the filter 100 is connected to the basket 20 in this manner, the protrusions 128 provide a significant amount of vertical support to the filter 100, thereby inhibiting substantial downward movement of the filter 100 toward the bottom wall of the basket 20. Additionally, the latch projections 199 provide vertical support for the filter 100 by engaging the bottom surface of the filter body 110 and inhibit substantial downward movement of the filter 100.

To remove the filter 100 from the basket 20, an upward force is applied to the filter 100 causing the enlarged portion 196 to engage the stems 202 of the latch projections 199. The upward force must be sufficient to cause the enlarged portion 196 to move the stems 202 apart and allow the enlarged portion 196 to pass by the stems 202 to a position above the stems 202. After the enlarged portion 196 is above and free of the stems 202, the front edge 192 of the bottom wall 26 is removed from the recess 191 in the filter 100 and the filter 100 is disconnected from the basket 20.

It should be understood that the filter 100 can be removably connected to the litter box cleaning device 10 in a variety of other exemplary manners and it should be understood that any of the illustrated and described exemplary manners for removably connecting the filter 100 to the device 10 can be used in combination with one another. For example, the filter 100 may be removably connected to the device 10 by combining one of the locking mechanisms 168 shown in FIGS. 27 and 28, FIGS. 29 and 30, or FIGS. 31-33, and the interference fit between the protrusions 128 and the support members 108 or the recess 191 and the front edge 192 engagement.

Although the present invention has been shown and described with respect to several examples thereof, it should be understood by those skilled in the art that the foregoing and various other changes, omissions, and additions in the form and detail thereof may be made therein without departing from the spirit and scope of the present invention.

1. A litter box cleaning device comprising:
a basket including a bottom wall and a sidewall extending from the bottom wall, the bottom wall and the side wall together defining a receptacle for receiving debris;
a handle extending from the basket; and
a cover connected to the basket and operable to at least partially cover the receptacle when connected to the basket.

2. The litter box cleaning device of claim 1, wherein the cover is removably connected to the basket.

3. The litter box cleaning device of claim 2, wherein the sidewall includes a top edge and the cover is removably connected to the top edge.

4. The litter box cleaning device of claim 3, wherein the cover is removably connected to the sidewall via an interference fit.

5. The litter box cleaning device of claim 4, wherein the cover includes a recess and wherein at least a portion of the top edge of the sidewall is positionable in the recess to create the interference fit and connect the cover to the basket.

6. The litter box cleaning device of claim 3, wherein the cover is removably connected to the sidewall via a snap fit.

7. The litter box cleaning device of claim 6, wherein the top edge includes a lip and the cover includes a lip, and wherein the lip of the cover engages the lip of the top edge to create the snap fit and connect the cover to the basket.

8. The litter box cleaning device of claim 1, wherein the cover is translucent.

9. The litter box cleaning device of claim 1, wherein the cover is transparent.

10. The litter box cleaning device of claim 2, wherein the sidewall includes a top edge and a lip extending from the top edge, the lip extending along at least a substantial portion of the top edge, and wherein the cover includes an edge and a lip extending along at least a substantial portion of the edge of the cover, wherein the lips of the sidewall and the cover engage each other to removably connect the cover to the basket.

11. A litter box cleaning device comprising:
a basket including a bottom wall and a sidewall extending from the bottom wall, the bottom wall and the sidewall together defining a receptacle for receiving debris, the bottom wall having a front and a rear and including an aperture defined through the bottom wall near the rear of the bottom wall;
a handle extending from the basket; and
a filter supported by the basket and including at least one slot therethrough such that the filter is at least partially positioned in the receptacle and above the bottom wall with the filter connected to the basket.

12. The litter box cleaning device of claim 11, wherein the aperture is the sole aperture defined in the bottom wall.

13. The litter box cleaning device of claim 11, wherein the aperture defined in the bottom wall extends across a substantial width of the bottom wall.

14. The litter box cleaning device of claim 11, wherein the aperture defined in the bottom wall extends completely across a width of the bottom wall.

15. The litter box cleaning device of claim 11, wherein the bottom wall and at least a portion of the filter are oriented non-parallel to one another.

16. The litter box cleaning device of claim 11, wherein the filter includes a blade and a body extending from the blade at an obtuse angle, and wherein the bottom wall and the blade are parallel with one another and the body of the filter is non-parallel with the bottom wall with the filter connected to the basket.

17. The litter box cleaning device of claim 16, wherein the blade and the bottom wall are co-planar with one another.

18. The litter box cleaning device of claim 16, wherein the blade includes an angled surface to provide a sharp leading edge.

19. The litter box cleaning device of claim 16, wherein the at least one slot is defined in the body of the filter.

20. The litter box cleaning device of claim 11, wherein the filter includes a plurality of slots.

21. The litter box cleaning device of claim 11, wherein debris and loose litter are scooped with the litter box cleaning device such that the debris is positioned on the filter and the loose litter passes through the slot in the filter and falls onto the bottom wall, and wherein movement of the litter box cleaning device causes the loose litter to move along and toward the rear of the bottom wall and through the aperture defined in the bottom wall.

22. The litter box cleaning device of claim 11, wherein the filter is removably connected to the basket.

23. The litter box cleaning device of claim 22, further comprising a locking mechanism for removably connecting the filter to the basket.

24. The litter box cleaning device of claim 23, wherein the locking mechanism includes a support member supported by the basket and a protrusion supported by the filter, the support member defining a receptacle therein, and wherein the protrusion of filter inserts into the receptacle of the support member to removably connect the filter to the basket.

25. The litter box cleaning device of claim 23, wherein the locking mechanism includes a support shoulder extending from the sidewall of the basket and a locking pin supported by the basket, the locking pin being movable between a locked position, in which the locking pin is engageable with the filter, and an unlocked position, in which the locking pin is not engageable with the filter, and wherein the filter is connected to the basket with the filter supported on the support shoulder and the locking pin in the locked position, and wherein the filter is removable from the basket with the locking pin positioned in the unlocked position.

26. The litter box cleaning device of claim 23, wherein the locking mechanism includes a support shoulder extending from the sidewall of the basket and a detent extending from the sidewall of the basket, and wherein the filter is connected to the basket with the filter positioned between the support shoulder and the detent.

27. The litter box cleaning device of claim 23, wherein the locking mechanism includes a filter projection extending from the filter and a clasp supported by the basket and extending into the receptacle, the clasp including a pair of latching projections spaced apart from each other, and wherein the filter is connected to the basket with the filter projection disposed between the latching projections and is not connected to the basket with the filter projection not disposed between the latching projections.
